(19) United States
(12) Patent Application Publication
(10) Pub. No.: US 2026/0237341 A1
(43) Pub. Date: Aug. 13, 2026

(54) PIXEL CIRCUIT, PIXEL DRIVING CIRCUIT AND DISPLAY DEVICE

(71) Applicant: BOE TECHNOLOGY GROUP CO., LTD., Beijing (CN)

(72) Inventors: Yuzhen GUO, Beijing (CN); Haoliang ZHENG, Beijing (CN); Minghua XUAN, Beijing (CN); Li XIAO, Beijing (CN); Jiao ZHAO, Beijing (CN); Xiaorong CUI, Beijing (CN); Chenyang ZHANG, Beijing (CN); Wanzhi CHEN, Beijing (CN)

(73) Assignee: BOE TECHNOLOGY GROUP CO., LTD., Beijing (CN)

(21) Appl. No.: 18/263,632

(22) PCT Filed: Sep. 1, 2022
(86) PCT No.: PCT/CN2022/116456

§ 371 Date: Jul. 31, 2023

(51) Int. Cl. G09G 3/32

(52) U.S. Cl. CPC G09G 3/32; G09G 2300/043; G09G 2300/0819; G09G 2310/08; G09G 2320/0233; G09G 2320/064

(57) ABSTRACT

A pixel circuit including a first light emitting control circuit, a light emitting element, a driving circuit and a light emitting gating circuit; the light emitting gating circuit generates a current path between the second terminal of the driving circuit and the light emitting element under the control of the light emitting control voltage provided by the light emitting control voltage terminal in the light emitting phase according to the light emitting data voltage provided by the light emitting data voltage terminal under the control of the first control signal provided by the first control terminal, control the driving circuit to control the light emitting element to emit light, or, to generate a current path between the second terminal of the driving circuit and the light emitting element during the light emitting phase, to control the driving circuit to control the light emitting element to emit light.

### TECHNICAL FIELD

The present disclosure relates to the field of display technology, in particular to a pixel circuit, a pixel driving circuit and a display device.

### BACKGROUND

The light emitting element (the light emitting element can be, for example, a mini LED or a micro LED) has the problems of poor brightness uniformity at low current density, insufficient low gray-scale control capability, and poor low gray-scale brightness control capability.

### SUMMARY

In a first aspect, the present disclosure provides in some embodiments a pixel circuit including a first light emitting control circuit, a light emitting element, a driving circuit and a light emitting gating circuit; the first light emitting control circuit is electrically connected to a first light emitting control terminal, a first voltage terminal and a first terminal of the driving circuit respectively, and is configured to control to connect the first voltage terminal and the first terminal of the driving circuit under the control of a first light emitting control signal provided by the first light emitting control terminal during a light emitting phase; a second terminal of the driving circuit is electrically connected to a first electrode of the light emitting element, and the driving circuit is configured to drive the light emitting element; the light emitting gating circuit is configured to, under the control of a first control signal provided by a first control terminal, according to a light emitting data voltage provided by a light emitting data voltage terminal, in the light emitting phase, generate a current path between the second terminal of the driving circuit and the light emitting element under the control of a light emitting control voltage provided by a light emitting control voltage terminal, to control the driving circuit to control the light emitting element to emit light, or, to generate the current path between the second terminal of the driving circuit and the light emitting element in the light emitting phase, to control the driving circuit to control the light emitting element to emit light.

Optionally, the light emitting gating circuit comprises a second light emitting control circuit and a first gating control circuit; the first gating control circuit is electrically connected to the first control terminal, the light emitting data voltage terminal, a gating control terminal, a second light emitting control terminal, the light emitting control voltage terminal and a first light emitting control terminal, is configured to write the light emitting data voltage provided by the light emitting data voltage terminal into the gating control terminal under the control of the first control signal, and under the control of a potential of the gating control terminal, control to connect the second light emitting control terminal and the light emitting control voltage terminal, or control to connect the second light emitting control terminal and the first light emitting control terminal; the second light emitting control circuit is electrically connected to the second light emitting control terminal, the second terminal of the driving circuit and the first electrode of the light emitting element respectively, and is configured to control to connect the second terminal of the driving circuit and the first electrode of the light emitting element under the control of a potential of the second light emitting control terminal; the second electrode of the light emitting element is electrically connected to a second voltage terminal.

Optionally, the light emitting gating circuit further comprises a first capacitor; a first terminal of the first capacitor is electrically connected to the gating control terminal, and a second terminal of the first capacitor is electrically connected to the first initial voltage terminal.

Optionally, the first gating control circuit comprises a first transistor, a second transistor and a third transistor; a control electrode of the first transistor is electrically connected to the first control terminal, a first electrode of the first transistor is electrically connected to the light emitting data voltage terminal, and a second electrode of the first transistor is electrically connected to the gating control terminal; a control electrode of the second transistor is electrically connected to the gating control terminal, a first electrode of the second transistor is electrically connected to the light emitting control voltage terminal, and a second electrode of the second transistor is electrically connected to the second light emitting control terminal; a control electrode of the third transistor is electrically connected to the gating control terminal, a first electrode of the third transistor is electrically connected to the first light emitting control terminal, and a second electrode of the third transistor is electrically connected to the second light emitting control terminal.

Optionally, the second light emitting control circuit comprises a fourth transistor; a control electrode of the fourth transistor is electrically connected to the second light emitting control terminal, a first electrode of the fourth transistor is electrically connected to the second terminal of the driving circuit, and a second electrode of the fourth transistor is electrically connected to the first electrode of the light emitting element.

Optionally, the first transistor is an n-type transistor, the second transistor is a p-type transistor, and the third transistor is an n-type transistor; or, the first transistor is an n-type transistor, the second transistor is an n-type transistor, and the third transistor is a p-type transistor; or, the first transistor is a p-type transistor, the second transistor is an n-type transistor, and the third transistor is a p-type transistor.

Optionally, when the second transistor is a p-type transistor and the third transistor is an n-type transistor, a width-to-length ratio of a channel of the third transistor is greater than a width-to-length ratio of a channel of the second transistor.

Optionally, the light emitting gating circuit includes a second gating control circuit, a third light emitting control circuit, and a fourth light emitting control circuit; the second gating control circuit is electrically connected to the first control terminal, the light emitting data voltage terminal, and the gating control terminal, and is configured to control to write the light emitting data voltage into the gating control terminal under the control of the first control signal; the third light emitting control circuit is electrically connected to the gating control terminal, the second electrode of the light emitting element and the second voltage terminal, and is configured to control to connect the second electrode of the light emitting element and the second voltage terminal under the control of the potential of the gating control terminal; the fourth light emitting control circuit is electrically connected to the light emitting control voltage terminal, the second electrode of the light emitting element and the second voltage terminal respectively, and is configured to control to connect the second electrode of the light emitting element and the second voltage terminal under the control of the light emitting control voltage provided by the light emitting control voltage terminal.

Optionally, the pixel circuit further includes a fifth light emitting control circuit; wherein the fifth light emitting control circuit is electrically connected to the first light emitting control terminal, the second terminal of the driving circuit and the first electrode of the light emitting element respectively, and is configured to control to connect the second terminal of the driving circuit and the first electrode of the light emitting element under the control of the first light emitting control signal.

Optionally, the light emitting gating circuit further comprises a second capacitor; a first terminal of the second capacitor is electrically connected to the gating control terminal, a second terminal of the second capacitor is electrically connected to the first initial voltage terminal.

Optionally, the second gating control circuit includes a fifth transistor, the third light emitting control circuit includes a sixth transistor, and the fourth light emitting control circuit includes a seventh transistor; a control electrode of the fifth transistor is electrically connected to the first control terminal, a first electrode of the fifth transistor is electrically connected to the light emitting data voltage terminal, and a second electrode of the fifth transistor is electrically connected to the gating control terminal; a control electrode of the sixth transistor is electrically connected to the gating control terminal, a first electrode of the sixth transistor is electrically connected to the second electrode of the light emitting element, a second electrode of the sixth transistor is electrically connected to the second voltage terminal; a control electrode of the seventh transistor is electrically connected to the light emitting control voltage terminal, a first electrode of the seventh transistor is electrically connected to the second electrode of the light emitting element, and a second electrode of the seventh transistor is electrically connected to the second voltage terminal.

Optionally, the seventh transistor is a p-type transistor, the sixth transistor is an n-type transistor, and the fifth transistor is an n-type transistor; or, the seventh transistor is a p-type transistor, the sixth transistor is an n-type transistor, and the fifth transistor is a p-type transistor; or, the seventh transistor is an n-type transistor, the sixth transistor is a p-type transistor, and the fifth transistor is an n-type transistor; or, the seventh transistor is an n-type transistor, the sixth transistor is a p-type transistor, and the fifth transistor is a p-type transistor.

Optionally, the pixel circuit further includes a data writing-in circuit, a compensation control circuit, a first initialization circuit, a second initialization circuit and a third capacitor; the data writing-in circuit is electrically connected to a second control terminal, a data line and the first terminal of the driving circuit, and is configured to write the data voltage provided by the data line into the first terminal of the driving circuit under the control of a second control signal provided by the second control terminal; the compensation control circuit is electrically connected to a third control terminal, the control terminal of the driving circuit and the second terminal of the driving circuit respectively, and is configured to control to connect the control terminal of the driving circuit and the second terminal of the driving circuit under the control of a third control signal provided by the third control terminal; the first initialization circuit is electrically connected to a first reset control terminal, the control terminal of the driving circuit and a third initial voltage terminal respectively, and is configured to write a third initial voltage provided by the third initial voltage terminal into the control terminal of the driving circuit under the control of a first reset control signal provided by the first reset control terminal; the second initialization circuit is electrically connected to a second reset control terminal, the first electrode of the light emitting element and a fourth initial voltage terminal respectively, and is configured to write a fourth initial voltage provided by the fourth initial voltage terminal into the first electrode of the light emitting element under the control of a second reset control signal provided by the second reset control terminal; a first terminal of the third capacitor is electrically connected to the control terminal of the driving circuit, and a second terminal of the third capacitor is electrically connected to the first voltage terminal.

Optionally, the first initialization circuit includes an eighth transistor, the compensation control circuit includes a ninth transistor, the data writing-in circuit includes a tenth transistor, and the second initialization circuit includes an eleventh transistor; a control electrode of the eighth transistor is electrically connected to the first reset control terminal, a first electrode of the eighth transistor is electrically connected to the third initial voltage terminal, and the a electrode of the eighth transistor is electrically connected to the control terminal of the driving circuit; a control electrode of the ninth transistor is electrically connected to the third control terminal, a first electrode of the ninth transistor is electrically connected to the control terminal of the driving circuit, and a second electrode of the ninth transistor is electrically connected to the second terminal of the driving circuit; a control electrode of the tenth transistor is electrically connected to the second control terminal, a first electrode of the tenth transistor is electrically connected to the data line, and a second electrode of the tenth transistor is electrically connected to the first terminal of the driving circuit; or the control electrode of the tenth transistor is electrically connected to the first reset control terminal, the first electrode of the tenth transistor is electrically connected to the light emitting data voltage terminal, and a second electrode of the tenth transistor is electrically connected to the first terminal of the driving circuit; a control electrode of the eleventh transistor is electrically connected to the second reset control terminal or the first reset control terminal, a first electrode of the eleventh transistor is electrically connected to the fourth initial voltage terminal, and a second electrode of the eleventh transistor is electrically connected to the first electrode of the light emitting element.

Optionally, the eighth transistor and the ninth transistor are oxide thin film transistors.

Optionally, the eleventh transistor is an oxide thin film transistor, and a control electrode of the eleventh transistor is electrically connected to the first reset control terminal.

Optionally, at least one of the eighth transistor and the ninth transistor is a double-gate transistor.

Optionally, the light emitting element is a micro light emitting diode or a miniature light emitting diode.

In a second aspect, an embodiment of the present disclosure provides a pixel driving method, applied to the pixel circuit according to any one of claims 1 to 18, comprising: controlling, by the first light emitting control circuit, to connect the first voltage terminal and the first terminal of the driving circuit under the control of the first light emitting control signal in the light emitting phase; controlling, by the light emitting gating circuit, under the control of the first control signal, according to the light emitting data voltage, in the light emitting phase, to generate a current path between the second terminal of the driving circuit and the light emitting element under the control of the light emitting control voltage provided by the light emitting control voltage terminal, to control the driving circuit to control the light emitting element to emit light, or to control to generate the current path between the second terminal of the driving circuit and the light emitting element in the light emitting phase, to control the driving circuit to control the light emitting element to emit light.

Optionally, the light emitting gating circuit includes a second light emitting control circuit and a first gating control circuit; the pixel driving method includes: writing, by the first gating control circuit, the light emitting data voltage into the gating control terminal under the control of the first control signal, and controlling to connect the second light emitting control terminal and the light emitting control voltage terminal or connect the second light emitting control terminal and the first light emitting control terminal under the control of a potential of the gating control terminal; controlling, by the second light emitting control circuit, to connect the second terminal of the driving circuit and the first electrode of the light emitting element under the control of a potential of the second light emitting control terminal.

Optionally, the light emitting gating circuit includes a second gating control circuit, a third light emitting control circuit, and a fourth light emitting control circuit; the pixel driving method includes: writing, by the second gating control circuit, the light emitting control voltage into the gating control terminal under the control of the first control signal; controlling, by the third light emitting control circuit, to connect the second electrode of the light emitting element and the second voltage terminal under the control of a potential of the gating control terminal; controlling, by the fourth light emitting control circuit, to connect the second electrode of the light emitting element and the second voltage terminal under the control of the light emitting control voltage.

In a third aspect, an embodiment of the present disclosure provides a display device including the pixel circuit.

### BRIEF DESCRIPTION OF THE DRAWINGS

FIG. 1 is a structural diagram of a pixel circuit according to at least one embodiment of the present disclosure;

FIG. 2 is a structural diagram of a pixel circuit according to at least one embodiment of the present disclosure;

FIG. 3 is a waveform diagram of the potential of the second light emitting control terminal EM2 according to at least one embodiment of the present disclosure;

FIG. 4 is a structural diagram of a pixel circuit according to at least one embodiment of the present disclosure;

FIG. 5 is a structural diagram of a pixel circuit according to at least one embodiment of the present disclosure;

FIG. 6 is a structural diagram of a pixel circuit according to at least one embodiment of the present disclosure;

FIG. 7A is a circuit diagram of a pixel circuit according to at least one embodiment of the present disclosure;

FIG. 7B is a circuit diagram of a pixel circuit according to at least one embodiment of the present disclosure;

FIG. 8 is a working timing diagram of the pixel circuit shown in FIG. 7A;

FIG. 9 is a working timing diagram of a simulation of the pixel circuit shown in FIG. 7A;

FIG. 10 is a circuit diagram of a pixel circuit according to at least one embodiment of the present disclosure;

FIG. 11 is a working timing diagram of the pixel circuit shown in FIG. 10;

FIG. 12 is a circuit diagram of a pixel circuit according to at least one embodiment of the present disclosure;

FIG. 13 is a circuit diagram of a pixel circuit according to at least one embodiment of the present disclosure;

FIG. 14 is a circuit diagram of a pixel circuit according to at least one embodiment of the present disclosure;

FIG. 15 is a circuit diagram of a pixel circuit according to at least one embodiment of the present disclosure;

FIG. 16 is a working timing diagram of the pixel circuit shown in FIG. 15;

FIG. 17 is a waveform diagram of the potential of the gating control terminal ch and the second light emitting control signal provided by the second light emitting control terminal EM2 according to at least one embodiment of the present disclosure;

FIG. 18 is a working timing diagram of a simulation of the pixel circuit shown in FIG. 15;

FIG. 19 is a circuit diagram of a pixel circuit according to at least one embodiment of the present disclosure;

FIG. 20 is a working timing diagram of the pixel circuit shown in FIG. 19;

FIG. 21 is a circuit diagram of a pixel circuit according to at least one embodiment of the present disclosure;

FIG. 22 is a circuit diagram of a pixel circuit according to at least one embodiment of the present disclosure;

FIG. 23 is a circuit diagram of a pixel circuit according to at least one embodiment of the present disclosure;

FIG. 24 is a working timing diagram of the pixel circuit shown in FIG. 23;

FIG. 25 is a circuit diagram of a pixel circuit according to at least one embodiment of the present disclosure;

FIG. 26 is a working timing diagram of the pixel circuit shown in FIG. 25;

FIG. 27 is a structural diagram of a pixel circuit according to at least one embodiment of the present disclosure;

FIG. 28 is a structural diagram of a pixel circuit according to at least one embodiment of the present disclosure;

FIG. 29 is a structural diagram of a pixel circuit according to at least one embodiment of the present disclosure;

FIG. 30 is a circuit diagram of a pixel circuit according to at least one embodiment of the present disclosure;

FIG. 31 is a working timing diagram of the pixel circuit shown in FIG. 30;

FIG. 32 is a circuit diagram of a pixel circuit according to at least one embodiment of the present disclosure;

FIG. 33 is a circuit diagram of a pixel circuit according to at least one embodiment of the present disclosure;

FIG. 34 is a working timing diagram of the pixel circuit shown in FIG. 33;

FIG. 35 is a circuit diagram of a pixel circuit according to at least one embodiment of the present disclosure.

### DETAILED DESCRIPTION

The following will clearly and completely describe the technical solutions in the embodiments of the present disclosure with reference to the accompanying drawings in the embodiments of the present disclosure. Apparently, the described embodiments are only some of the embodiments of the present disclosure, not all of them. Based on the embodiments in the present disclosure, all other embodiments obtained by a person ordinary skilled in the art without making creative work belong to the protection scope of the present disclosure.

The transistors used in all the embodiments of the present disclosure may be triodes, thin film transistors or field effect transistors or other devices with the same characteristics. In the embodiments of the present disclosure, in order to distinguish the two electrodes of the transistor except the control electrode, one electrode is called the first electrode, and the other electrode is called the second electrode.

In actual operation, when the transistor is a triode, the control electrode can be a base, the first electrode can be a collector, and the second electrode can be an emitter; or, the control electrode can be a base, the first electrode may be an emitter, and the second electrode may be a collector.

In actual operation, when the transistor is a thin film transistor or a field effect transistor, the control electrode may be a gate electrode, the first electrode may be a drain electrode, and the second electrode may be a source electrode; or, the control electrode may be a gate electrode, the first electrode may be a source electrode, and the second electrode may be a drain electrode.

The pixel circuit described in the embodiment of the present disclosure includes a first light emitting control circuit, a light emitting element, a driving circuit and a light emitting gating circuit;

The first light emitting control circuit is electrically connected to a first light emitting control terminal, a first voltage terminal and a first terminal of the driving circuit respectively, and is configured to control to connect the first voltage terminal and the first terminal of the driving circuit under the control of a first light emitting control signal provided by the first light emitting control terminal during a light emitting phase;

A second terminal of the driving circuit is electrically connected to a first electrode of the light emitting element, and the driving circuit is configured to drive the light emitting element;

The light emitting gating circuit is configured to form a current path between the second terminal of the driving circuit and the light emitting element under the control of the light emitting control voltage provided by the light emitting control voltage terminal in the light emitting phase according to the light emitting data voltage provided by the light emitting data voltage terminal under the control of the first control signal provided by the first control terminal, so as to control the driving circuit to control the light emitting element to emit light, or, to form a current path between the second terminal of the driving circuit and the light emitting element during the light emitting phase, to control the driving circuit to control the light emitting element to emit light.

In at least one embodiment of the present disclosure, the light emitting control voltage may be a pulse width modulation (PWM) signal, and the light emitting control voltage may be a high frequency signal, but not limited thereto.

When the pixel circuit described in the embodiments of the present disclosure is working, in the light emitting phase, the light emitting gating circuit forms the current path between the second terminal of the driving circuit and the light emitting element under the control of the first control signal, according to the light emitting data voltage, and under the control of the light emitting control voltage, to control the light emitting element to emit light at high frequency for a short time to achieve low gray scale, and the PWM dimming method is adopted; or, in the light emitting phase, the light emitting element is controlled to emit light for a long time (which refers to: the light emitting element emits light at all times in the light emitting phase, and the gray scale is completely determined by the data voltage at this time), so as to achieve high gray scale, the Pulse Amplitude Modulation (PAM) method is used. The embodiments of the present disclosure can improve the brightness control capability of high and low gray scales.

In at least one embodiment of the present disclosure, the light emitting control voltage may be a high-frequency PWM signal. When the light emitting gating circuit forms a current path between the second terminal of the driving circuit and the light emitting element under the control of the light emitting control voltage, the light emitting element emits light for a short time multiple times. The higher the frequency of the light emitting control voltage is, the less flicker can be detected by human eyes. Since the light emitting time duration is reduced, low gray scales can be achieved.

The pixel circuit described in the embodiments of the present disclosure can perform PWM dimming to solve the problems of poor brightness uniformity and insufficient low-gray-scale control ability of the light emitting element at low current density, and can improve the low-gray-scale brightness control ability.

The embodiment of the present disclosure is a pixel circuit with PWM dimming function, which solves the problem of poor brightness uniformity under low current density, adopts the PAM mode for long-time light emitting under high gray scale, and adopts the PWM mode for short time high frequency light emitting under low gray scale.

In at least one embodiment of the present disclosure, the light emitting gating circuit includes a second light emitting control circuit and a first gating control circuit;

The first gating control circuit is electrically connected to the first control terminal, the light emitting data voltage terminal, a gating control terminal, a second light emitting control terminal, a light emitting control voltage terminal and a first light emitting control terminal, is configured to write the light emitting data voltage provided by the light emitting data voltage terminal into the gating control terminal under the control of the first control signal, and under the control of a potential of the gating control terminal, control to connect the second light emitting control terminal and the light emitting control voltage terminal, or control to connect the second light emitting control terminal and the first light emitting control terminal;

The second light emitting control circuit is electrically connected to the second light emitting control terminal, the second terminal of the driving circuit and the first electrode of the light emitting element respectively, and is configured to control to connect the second terminal of the driving circuit and the first electrode of the light emitting element under the control of the potential of the second light emitting control terminal;

The second electrode of the light emitting element is electrically connected to the second voltage terminal.

In specific implementation, the light emitting gating circuit may include a second light emitting control circuit and a first gating control circuit, and the first gating control circuit controls the connection between the second light emitting control terminal and the light emitting control voltage terminal, or controls the connection between the second light emitting control terminal and the first light emitting control terminal, and the second light emitting control circuit controls to connect the second terminal of the driving circuit and the first electrode of the light emitting element under the control of the potential of the second light emitting control terminal.

Optionally, the first voltage terminal may be a high voltage terminal, and the second voltage terminal may be a low voltage terminal, but not limited thereto.

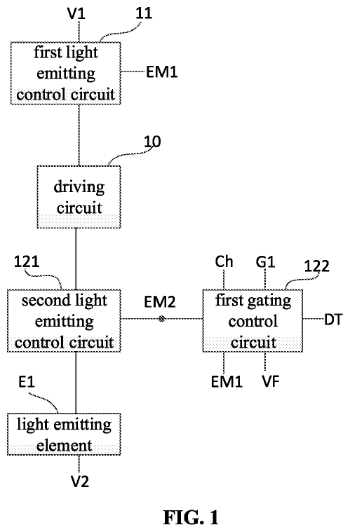

As shown in FIG. 1, the pixel circuit described in at least one embodiment of the present disclosure includes a first light emitting control circuit 11, a light emitting element E1, a driving circuit 10, and a light emitting gating circuit;

The first light emitting control circuit 11 is electrically connected to the first light emitting control terminal EM1, the first voltage terminal V1 and the first terminal of the driving circuit 10 respectively, and is configured to control to connect the first voltage terminal V1 and the first terminal of the driving circuit 10 under the control of the first light emitting control signal provided by the first light emitting control terminal EM1 during the light emitting phase;

The second terminal of the driving circuit 10 is electrically connected to the first electrode of the light emitting element E1, and the driving circuit 10 is configured to drive the light emitting element E1;

The light emitting gating circuit includes a second light emitting control circuit 121 and a first gating control circuit 122;

The first gating control circuit 122 is respectively connected to the first control terminal G1, the light emitting data voltage terminal DT, the gating control terminal ch, the second light emitting control terminal EM2, the light emitting control voltage terminal VF and the first light emitting control terminal EM1, and is configured to write the light emitting data voltage provided by the light emitting data voltage terminal DT into the gating control terminal ch under the control of the first control signal provided by the first control terminal G1, under the control of the potential of the gating control terminal ch, control to connect the second light emitting control terminal EM2 and the light emitting control voltage terminal VF, or control to connect the second light emitting control terminal EM2 and the first light emitting control terminal EM1;

The second light emitting control circuit 121 is electrically connected to the second light emitting control terminal EM2, the second terminal of the driving circuit 10 and the first electrode of the light emitting element E1 respectively, controls to connect the second terminal of the driving circuit 10 and the first electrode of the light emitting element E1 under the control of the potential of the second light emitting control terminal EM2;

The second electrode of the light emitting element E1 is electrically connected to the second voltage terminal V2.

When at least one embodiment of the pixel circuit shown in FIG. 1 of the present disclosure is in operation, the display period may include a data writing-in phase and a light emitting phase that are set successively;

In the data writing-in phase, the first gating control circuit 122 writes the light emitting data voltage into the gating control terminal ch under the control of the first control signal, and control to connect the second light emitting control terminal EM2 and the light emitting control voltage terminal VF or control to connect the second light emitting control terminal EM2 and the first light emitting control terminal EM1 under the control of the potential of the gating control terminal ch;

In the light emitting phase, the second light emitting control circuit 121 controls to connect the second terminal of the driving circuit 10 and the first electrode of the light emitting element E1 under the control of the potential of the second light emitting control terminal EM2;

In the light emitting phase, when the second light emitting control terminal EM2 is connected to the light emitting control voltage terminal VF, the light emitting element E1 emits light for a short time at high frequency to achieve low grayscale display; when the second light emitting control terminal EM2 is connected to the first light emitting control terminal EM1, in the light emitting phase, the light emitting element E1 emits light for a long time to realize high gray scale display.

Optionally, the light emitting gating circuit further includes a first capacitor;

A first terminal of the first capacitor is electrically connected to the gating control terminal, and a second terminal of the first capacitor is electrically connected to the first initial voltage terminal.

Optionally, the first gating control circuit includes a first transistor, a second transistor and a third transistor;

A control electrode of the first transistor is electrically connected to the first control terminal, a first electrode of the first transistor is electrically connected to the light emitting data voltage terminal, and a second electrode of the first transistor is electrically connected to the gating control terminal;

A control electrode of the second transistor is electrically connected to the gating control terminal, a first electrode of the second transistor is electrically connected to the light emitting control voltage terminal, and a second electrode of the second transistor is electrically connected to the second light emitting control terminal;

A control electrode of the third transistor is electrically connected to the gating control terminal, a first electrode of the third transistor is electrically connected to the first light emitting control terminal, and a second electrode of the third transistor is electrically connected to the second light emitting control terminal.

Optionally, the second light emitting control circuit includes a fourth transistor;

A control electrode of the fourth transistor is electrically connected to the second light emitting control terminal, a first electrode of the fourth transistor is electrically connected to the second terminal of the driving circuit, and a second electrode of the fourth transistor is electrically connected to the first electrode of the light emitting element.

Optionally, the first transistor is an n-type transistor, the second transistor is a p-type transistor, and the third transistor is an n-type transistor; or,

The first transistor is an n-type transistor, the second transistor is an n-type transistor, and the third transistor is a p-type transistor; or,

The first transistor is a p-type transistor, the second transistor is an n-type transistor, and the third transistor is a p-type transistor;

But not limited to this.

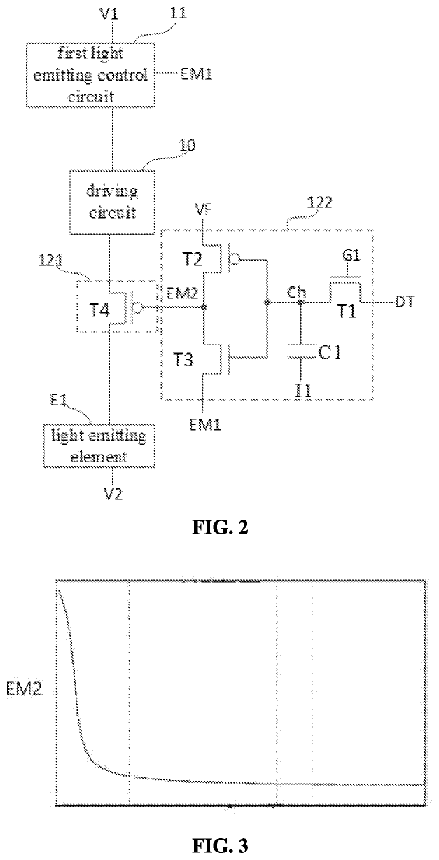

As shown in FIG. 2, on the basis of at least one embodiment of the pixel circuit shown in FIG. 1 of the present disclosure, the light emitting gating circuit further includes a first capacitor C1;

The first terminal of the first capacitor C1 is electrically connected to the gating control terminal ch, and the second terminal of the first capacitor C1 is electrically connected to the first initial voltage terminal I1; the first initial voltage terminal I1 is used for providing the first initial voltage Vini1;

The first gating control circuit 122 includes a first transistor T1, a second transistor T2 and a third transistor T3;

The gate electrode of the first transistor T1 is electrically connected to the first control terminal G1, the source electrode of the first transistor T1 is electrically connected to the light emitting data voltage terminal DT, and the drain electrode of the first transistor T1 is electrically connected to the gating control terminal ch;

The gate electrode of the second transistor T2 is electrically connected to the gating control terminal ch, the source electrode of the second transistor T2 is electrically connected to the light emitting control voltage terminal VF, and the drain electrode of the second transistor T2 is electrically connected to the second light emitting control terminal EM2; the light emitting control voltage terminal VF is configured to provide a light emitting control voltage HF;

The gate electrode of the third transistor T3 is electrically connected to the gating control terminal ch, the source electrode of the third transistor T3 is electrically connected to the first light emitting control terminal EM1, and the drain electrode of the third transistor T3 is electrically connected to the second light emitting control terminal EM2;

The second light emitting control circuit 121 includes a fourth transistor T4;

The gate electrode of the fourth transistor T4 is electrically connected to the second light emitting control terminal EM2, the source electrode of the fourth transistor T4 is electrically connected to the second terminal of the driving circuit 10, and the drain electrode of the fourth transistor T4 is electrically connected to the first electrode of the light emitting element E1.

In at least one embodiment of the pixel circuit shown in FIG. 2, T1 is an n-type transistor, T2 is a p-type transistor, T3 is an n-type transistor, and T4 is a p-type transistor, but not limited thereto.

When at least one embodiment of the pixel circuit shown in FIG. 2 of the present disclosure is in operation, the display period may include a data writing-in phase and a light emitting phase that are set successively;

In the data writing-in phase, G1 provides a high-voltage signal, EM1 provides a high-voltage signal, T1 is turned on, so as to write the light emitting data voltage provided by DT into the gating control terminal ch, and C1 maintains the potential of the gating control terminal ch; when the light emitting data voltage is a high voltage, T3 can be turned on during the data writing-in phase and the light emitting phase; when the light emitting data voltage is a low voltage, T2 can be turned on during the data writing-in phase and the light emitting phase;

In the light emitting phase, when T3 is turned on, EM2 and EM1 are connected, and the light emitting element E1 emits light for a long time; when T2 is turned on, EM2 and VF are connected, EM2 is connected to the light emitting control voltage HF, and the light emitting element E1 emits light for a short time at the high-frequency.

At least one embodiment of the pixel circuit shown in FIG. 2 of the present disclosure is working. When PAM emits light for a long time, the high voltage signal provided by DT needs to enter the gate electrode of T3 through T1 to turn on T3, so that the high voltage signal or the low voltage signal provided by EM1 is passed, a higher turn-on voltage is required when the high voltage signal provided by EM1 passes through, so the demand for the first control signal provided by G1 is greater, which can be solved by the following solution. When DT provides a high voltage signal, the light emitting data voltage provided by DT is lower, and the light emitting data voltage can turn on T2 when HF is a high voltage, provide a high voltage signal for EM2 through HF, and turn off T2 when HF is a low voltage; at the same time, T3 can be turned off when EM1 provides a high voltage signal, and T3 can be turned on when EM1 provides a low voltage signal. The design cooperation required is: the width W3 of the channel of T3 is greater than the width W2 of the channel of T2, so that the width-to-length ratio of the channel of T3 is greater than the width-to-length ratio of the channel of T2, so that EM1 provides a low voltage signal while HF is a high voltage and the potential of EM2 is a low voltage. In actual operation, W3 is larger than W2. When EM1 provides a low voltage signal and HF is a high voltage, as shown in FIG. 3, the potential of EM2 is closer to the low voltage signal provided by EM1; on the contrary, the potential of EM2 is closer to the high voltage of HF.

Optionally, W3 may be twice of W2, but not limited thereto.

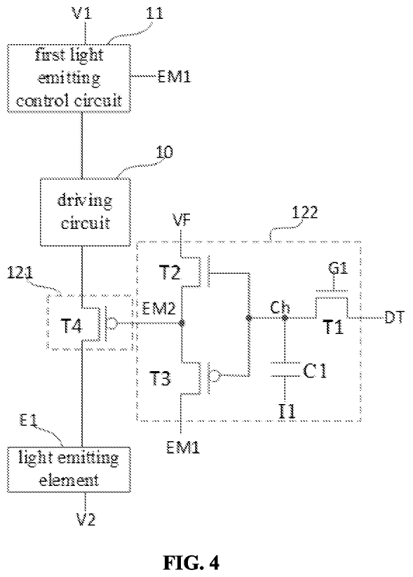

The difference between at least one embodiment of the pixel circuit shown in FIG. 4 of the present disclosure and at least one embodiment of the pixel circuit shown in FIG. 2 of the present disclosure is that the second transistor T2 is an n-type transistor, and the third transistor T3 is a p-type transistor.

When at least one embodiment of the pixel circuit shown in FIG. 4 of the present disclosure is in operation, the display period may include a data writing-in phase and a light emitting phase that are set successively;

In the data writing-in phase, G1 provides a high-voltage signal, EM1 provides a high-voltage signal, T1 is turned on, so as to write the light emitting data voltage provided by DT into the gating control terminal ch, and C1 maintains the potential of the gating control terminal ch; when the light emitting data voltage is a low voltage, T3 can be turned on during the data writing-in phase and the light emitting phase; when the light emitting data voltage is a high voltage, T2 can be turned on during the data writing-in phase and the light emitting phase;

In the light emitting phase, when T3 is turned on, EM2 and EM1 are connected, and the light emitting element E1 emits light for a long time; when T2 is turned on, EM2 and VF are connected, EM2 is connected to the light emitting control voltage HF, and the light emitting element E1 emits light in a short time at the high-frequency.

When at least one embodiment of the pixel circuit shown in FIG. 4 of the present disclosure is working, when DT provides a low-voltage signal in the data writing-in phase, in the light emitting phase, T3 needs to be turned on so that the low-voltage signal provided by EM1 passes through; when DT provides a high-voltage signal during the data writing-in phase, it is necessary to turn on T2 to allow HF to pass through; since the high-voltage and low-voltage provided by DT have a relatively large span, the potential requirements for the high-voltage signal provided by G1 are also relatively large; and, when the potential of the gating control terminal ch is maintained at a low voltage, T1 needs a lower turn-off voltage, so the high and low voltage span of the first control signal provided by G1 is relatively large.

At least one embodiment of the pixel circuit shown in FIG. 4 of the present disclosure is working. When the potential of ch is low in the data writing-in phase, T3 is turned on. After entering the light emitting phase, the potential of ch needs to maintain the voltage value of the low voltage signal provided by DT (the voltage value can be −9V, for example), to ensure the on state of T3, and if the voltage value of the low-voltage signal provided by G1 is −7V at this time, T1 is prone to reverse leakage, resulting in the increase of the potential of ch. Therefore, it is necessary to adjust the voltage value of the low-voltage signal provided by G1 to −12V to −9V (if T1 needs to be completely turned off so that there is no reverse leakage of ch, the voltage value of the low-voltage signal provided by G1 needs to be reduced to −12V, but from the consideration of meeting the demand, it is also possible to be reduced to −9V).

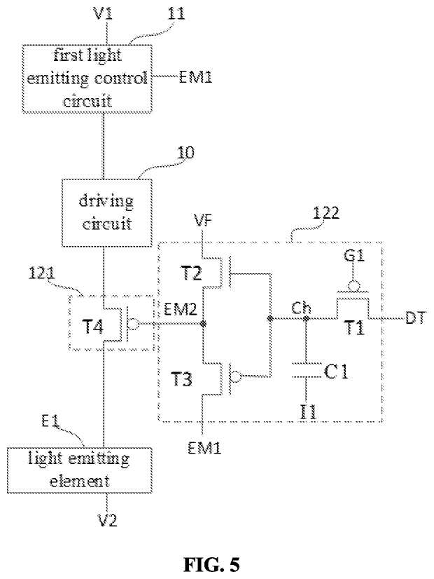

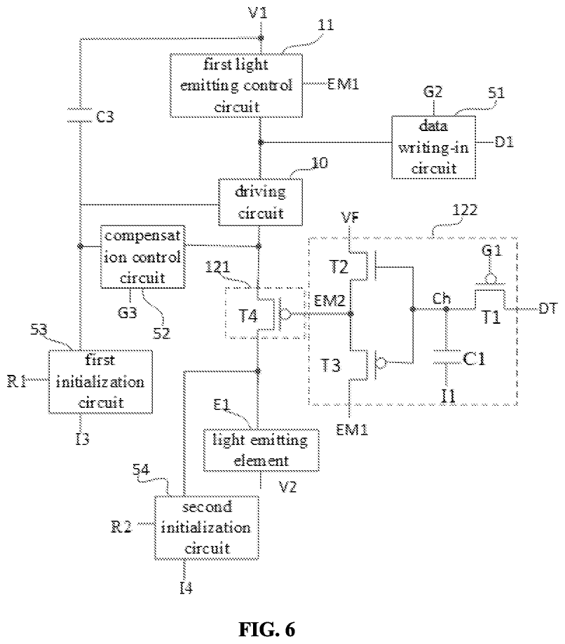

The difference between at least one embodiment of the pixel circuit shown in FIG. 5 of the present disclosure and at least one embodiment of the pixel circuit shown in FIG. 4 of the present disclosure is that T1 is a p-type transistor.

When at least one embodiment of the pixel circuit shown in FIG. 5 of the present disclosure is in operation, the display period may include a data writing-in phase and a light emitting phase that are set successively;

In the data writing-in phase, G1 provides a low-voltage signal, EM1 provides a high-voltage signal, T1 is turned on, so as to write the light emitting data voltage provided by DT into the gating control terminal ch, and C1 maintains the potential of the gating control terminal ch; when the light emitting data voltage is a low voltage, T3 can be turned on during the data writing-in phase and the light emitting phase; when the light emitting data voltage is a high voltage, T2 can be turned on during the data writing-in phase and the light emitting phase;

In the light emitting phase, when T3 is turned on, EM2 and EM1 are connected, and the light emitting element E1 emits light for a long time; when T2 is turned on, EM2 and VF are connected, EM2 is connected to the light emitting control voltage HF, and the light emitting element E1 emits light for a short time at the high-frequency.

In at least one embodiment of the present disclosure, when T2 is an n-type transistor, T3 is a p-type transistor; when T2 is a p-type transistor, T3 is an n-type transistor, which is Complementary Metal Oxide Semiconductor (CMOS) or Low Temperature polycrystalline oxide (LTPO) structure.

In a specific implementation, when T2 is an oxide transistor, the width of the channel of T2 may be greater than the width of the channel of T3, but not limited thereto.

The pixel circuit described in at least one embodiment of the present disclosure may further include a data writing-in circuit, a compensation control circuit, a first initialization circuit, a second initialization circuit, and a third capacitor;

The data writing-in circuit is electrically connected to the second control terminal, the data line and the first terminal of the driving circuit, and is configured to write the data voltage provided by the data line into the first terminal of the driving circuit under the control of the second control signal provided by the second control terminal, for data voltage writing-in;

The compensation control circuit is electrically connected to the third control terminal, the control terminal of the driving circuit and the second terminal of the driving circuit respectively, and is configured to control to connect the control terminal of the driving circuit and the second terminal of the driving circuit under the control of the third control signal provided by the third control terminal, for compensating the threshold voltage of the driving transistor included in the driving circuit;

The first initialization circuit is electrically connected to a first reset control terminal, the control terminal of the driving circuit and a third initial voltage terminal respectively, and is configured to write the third initial voltage provided by the third initial voltage terminal into the control terminal of the driving circuit under the control of the first reset control signal provided by the first reset control terminal, so as to initialize the potential of the control terminal of the driving circuit;

The second initialization circuit is electrically connected to a second reset control terminal, the first electrode of the light emitting element and a fourth initial voltage terminal respectively, and is configured to write the fourth initial voltage provided by the fourth initial voltage terminal into the first electrode of the light emitting element under the control of the second reset control signal provided by the second reset control terminal, so as to initialize the potential of the first electrode of the light emitting element;

A first terminal of the third capacitor is electrically connected to the control terminal of the driving circuit, and a second terminal of the third capacitor is electrically connected to the first voltage terminal.

Optionally, the first initial voltage terminal, the third initial voltage terminal and the fourth initial voltage terminal may be the same voltage terminal, but not limited thereto.

In at least one embodiment of the present disclosure, the third control terminal may be the same control terminal as the first control terminal, but not limited thereto.

Optionally, the first initialization circuit includes an eighth transistor, the compensation control circuit includes a ninth transistor, the data writing-in circuit includes a tenth transistor, and the second initialization circuit includes an eleventh transistor;

A control electrode of the eighth transistor is electrically connected to the first reset control terminal, a first electrode of the eighth transistor is electrically connected to the third initial voltage terminal, and the a electrode of the eighth transistor is electrically connected to the control terminal of the driving circuit;

A control electrode of the ninth transistor is electrically connected to the third control terminal, a first electrode of the ninth transistor is electrically connected to the control terminal of the driving circuit, and a second electrode of the ninth transistor is electrically connected to the second terminal of the driving circuit;

A control electrode of the tenth transistor is electrically connected to the second control terminal, a first electrode of the tenth transistor is electrically connected to the data line, and a second electrode of the tenth transistor is electrically connected to the first terminal of the driving circuit;

A control electrode of the eleventh transistor is electrically connected to the second reset control terminal, a first electrode of the eleventh transistor is electrically connected to the fourth initial voltage terminal, and a second electrode of the eleventh transistor is electrically connected to the first electrode of the light emitting element.

Optionally, the eighth transistor and the ninth transistor are oxide thin film transistors, to reduce leakage.

In at least one embodiment of the present disclosure, at least one of the eighth transistor and the ninth transistor may be a double-gate transistor to reduce leakage.

Optionally, the light emitting element is a micro light emitting diode or a miniature light emitting diode, but not limited thereto.

In at least one embodiment of the present disclosure, the first light emitting control circuit includes a twelfth transistor;

A control electrode of the twelfth transistor is electrically connected to the first light emitting control terminal, a first electrode of the twelfth transistor is electrically connected to the first voltage terminal, and a second electrode of the twelfth transistor is electrically connected to the first terminal of the driving circuit;

The driving circuit includes a driving transistor;

A control electrode of the driving transistor is electrically connected to the control terminal of the driving circuit, a first electrode of the driving transistor is electrically connected to the first terminal of the driving circuit, and a second electrode of the driving transistor is electrically connected to the second terminal of the driving circuit.

As shown in FIG. 6, on the basis of at least one embodiment of the pixel circuit shown in FIG. 1 of the present disclosure, the pixel circuit described in at least one embodiment of the present disclosure may further include a data writing-in circuit 51, a compensation control circuit 52, a first initialization circuit 53, a second initialization circuit 54 and a third capacitor C3; the light emitting element is a miniature light emitting diode M1;

The data writing-in circuit 51 is electrically connected to the second control terminal G2, the data line D1 and the first terminal of the driving circuit 10 respectively, and is configured to write the data voltage Vdata provided by the data line D1 into the first terminal of the driving circuit 10 under the control of the second control signal provided by the second control terminal G2;

The compensation control circuit 52 is electrically connected to the third control terminal G3, the control terminal of the driving circuit 10, and the second terminal of the driving circuit 10, respectively, is configured to control the control terminal of the driving circuit 10 and the second terminal of the driving circuit 10 under the control of the third control signal provided by the third control terminal G3;

The first initialization circuit 53 is electrically connected to the first reset control terminal R1, the control terminal of the driving circuit 10, and the third initial voltage terminal I3, respectively, is configured to write the third initial voltage provided by the third initial voltage terminal I3 into the control terminal of the driving circuit 10 under the control of the first reset control signal provided by the first reset control terminal R1, so as to initialize the potential of the control terminal of the driving circuit 10;

The second initialization circuit 54 is electrically connected to the second reset control terminal R2, the anode of the micro light emitting diode M1 and the fourth initial voltage terminal I4 respectively, and is configured to write the fourth initial voltage provided by the fourth initial voltage terminal I4 into the anode of the micro light emitting diode M1 under the control of the second reset control signal provided by the second reset control terminal R2;

A first terminal of the third capacitor C3 is electrically connected to the control terminal of the driving circuit 10, and a second terminal of the third capacitor C3 is electrically connected to the first voltage terminal V1.

In at least one embodiment of the pixel circuit shown in FIG. 6, the first initial voltage terminal, the third initial voltage terminal and the fourth initial voltage terminal may be the same voltage terminal, the first voltage terminal may be a high voltage terminal, the first control terminal and the third control terminal may be the same control terminal, but not limited thereto.

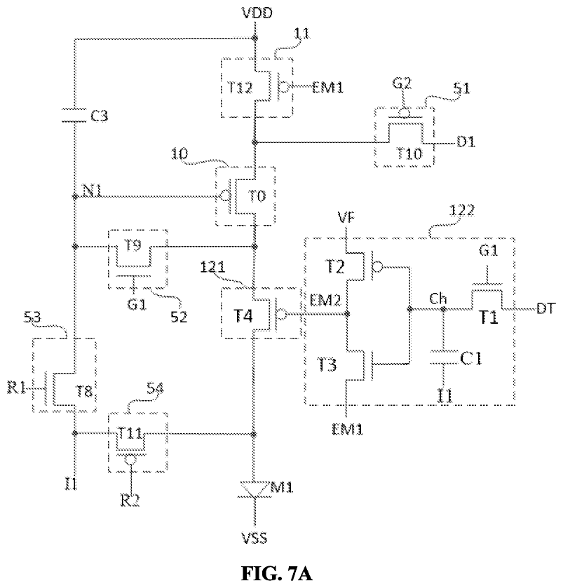

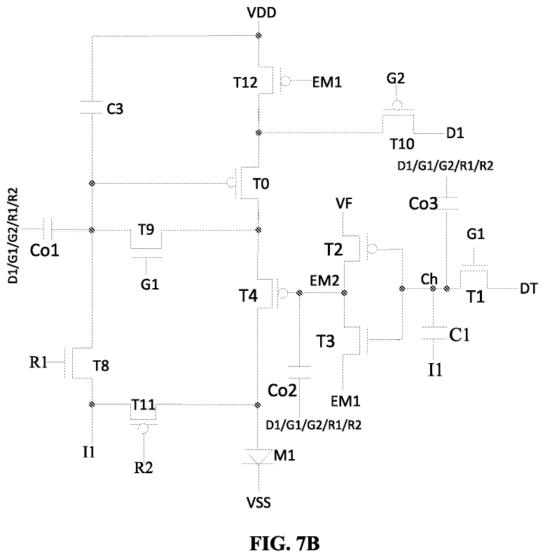

As shown in FIG. 7A, on the basis of at least one embodiment of the pixel circuit shown in FIG. 6, the light emitting gating circuit further includes a first capacitor C1; the driving circuit 10 includes a driving transistor T0;

The first terminal of the first capacitor C1 is electrically connected to the gating control terminal ch, and the second terminal of the first capacitor C1 is electrically connected to the first initial voltage terminal I1; the first initial voltage terminal I1 is configured to provide the first initial voltage Vini1;

The first gating control circuit 122 includes a first transistor T1, a second transistor T2 and a third transistor T3;

The gate electrode of the first transistor T1 is electrically connected to the first control terminal G1, the source electrode of the first transistor T1 is electrically connected to the light emitting data voltage terminal DT, and the drain electrode of the first transistor T1 is electrically connected to the gating control terminal ch;

The gate electrode of the second transistor T2 is electrically connected to the gating control terminal ch, the source electrode of the second transistor T2 is electrically connected to the light emitting control voltage terminal VF, and the drain electrode of the second transistor T2 is electrically connected to the second light emitting control terminal EM2; the light emitting control voltage terminal VF is configured to provide a light emitting control voltage HF;

The gate electrode of the third transistor T3 is electrically connected to the gating control terminal ch, the source electrode of the third transistor T3 is electrically connected to the first light emitting control terminal EM1, and the drain electrode of the third transistor T3 is electrically connected to the second light emitting control terminal EM2;

The second light emitting control circuit 121 includes a fourth transistor T4;

The gate electrode of the fourth transistor T4 is electrically connected to the second light emitting control terminal EM2, the source electrode of the fourth transistor T4 is electrically connected to the second terminal of the driving circuit 10, and the drain electrode of the fourth transistor T4 is electrically connected to the anode of the micro-LED M1; the cathode of the micro-LED M1 is electrically connected to the low voltage terminal VSS;

The first initialization circuit 53 includes an eighth transistor T8, the compensation control circuit 52 includes a ninth transistor T9, the data writing-in circuit 51 includes a tenth transistor T10, and the second initialization circuit 54 includes an eleventh transistor T11;

The gate electrode of the eighth transistor T8 is electrically connected to the first reset control terminal R1, the source electrode of the eighth transistor T8 is electrically connected to the first initial voltage terminal I1, and the drain electrode of the eighth transistor T8 is electrically connected to the gate electrode of the driving transistor T0;

The gate electrode of the ninth transistor T9 is electrically connected to the first control terminal G1, the source electrode of the ninth transistor T9 is electrically connected to the gate electrode of the driving transistor T0, and the drain electrode of the ninth transistor T9 electrically connected to the drain electrode of the driving transistor T0;

The gate electrode of the tenth transistor T10 is electrically connected to the second control terminal G2, the source electrode of the tenth transistor T10 is electrically connected to the data line D1, and the drain electrode of the tenth transistor T10 is electrically connected to the source electrode of the driving transistor T0;

The gate electrode of the eleventh transistor T11 is electrically connected to the second reset control terminal R2, the source electrode of the eleventh transistor T11 is electrically connected to the first initial voltage terminal I1, and the drain electrode of the eleventh transistor T11 is electrically connected to the anode of the miniature light emitting diode M1;

The first light emitting control circuit 11 includes a twelfth transistor T12;

The gate electrode of the twelfth transistor T12 is electrically connected to the first light emitting control terminal EM1, the source electrode of the twelfth transistor T12 is electrically connected to the high voltage terminal VDD, and the drain electrode of the twelfth transistor T12 is electrically connected to the source electrode of the driving transistor T0.

In FIG. 7A, the one labeled N1 is the first node, and the first node N1 is electrically connected to the gate electrode of T0.

In at least one embodiment of the pixel circuit shown in FIG. 7A, T1 is an n-type transistor, T2 is a p-type transistor, T3 is an n-type transistor, and T4 is a p-type transistor, but not limited thereto.

In at least one embodiment of the pixel circuit shown in FIG. 7A, the first voltage terminal is a high voltage terminal VDD, the second voltage terminal is a low voltage terminal VSS, the first control terminal and the third control terminal are the same control terminal, and the first initial voltage terminal, the third initial voltage terminal and the fourth initial voltage terminal are the same voltage terminal.

In at least one embodiment of the pixel circuit shown in FIG. 7A, T12, T0, T10, and T11 are p-type transistors, T8 and T9 are n-type transistors, and T12, T0, T10, and T11 are low-temperature polysilicon thin film transistors; but not limit thereto.

In at least one embodiment shown in FIG. 7A, T8 and T9 are oxide thin film transistors to reduce leakage and maintain the potential of the gate electrode of T0.

In at least one embodiment of the pixel circuit shown in FIG. 7A, T2 and T3 form an inverter-like structure, and the first light emitting control signal provided by EM1 and light emitting control voltage HF are respectively connected to both sides of the inverter-like structure as input signal.

In at least one embodiment of the pixel circuit shown in FIG. 7A, T8 can be replaced by a p-type transistor, T9 can be replaced by a p-type transistor, and T10 can be replaced by an n-type transistor, but not limited thereto.

In at least one embodiment of the pixel circuit shown in FIG. 7A, T1 can also be replaced by a p-type transistor, and the signal connected to the gate electrode of T1 can be inverted, but not limited thereto.

In at least one embodiment of the present disclosure, T0 is a driving transistor, and the length of the channel of T0 can be increased. For example, the length of the channel of T0 can be greater than or equal to 10 μm and less than or equal to 30 μm, and because T4 and T12 are in the light emitting current path, the width of the channel of T4 and the width of the channel of T12 can be appropriately increased. For example, the width of the channel of T4 and the width of the channel of T12 can be greater than or equal to 5 μm and less than or equal to 10 μm.

In at least one embodiment of the pixel circuit shown in FIG. 7A of the present disclosure, except for T0, T4, and T12, other transistors are switching transistors. When the switching transistor is a low-temperature polysilicon thin film transistor, the width to length ratio of the channel of the switching transistor can be 3 μm/3 μm; when the switch transistor is an oxide thin film transistor, the width-to-length ratio of the channel of the switch transistor can be within a fluctuation range centered on 5 μm/5 μm; but not limited thereto.

In FIG. 7B, on the basis of at least one embodiment of the pixel circuit shown in FIG. 7A, coupling capacitors are added as follows:
a first coupling capacitor Co1 between the gate electrode of T0 and the signal line;
A second coupling capacitor Co2 between the gate electrode of T4 and the signal line;
A third coupling capacitor Co3 between the gate electrode of T2 and the signal line;

The signal line may be at least one of: a data line, a first control terminal, a second control terminal, a first reset control terminal, and a second reset control terminal.

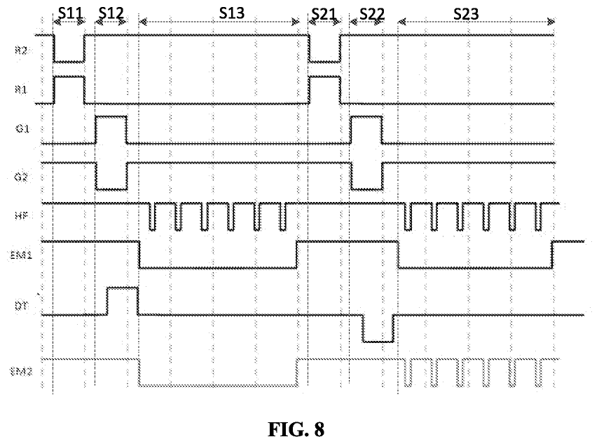

As shown in FIG. 8, when at least one embodiment of the pixel circuit shown in FIG. 7A of the present disclosure is in operation, the first display period includes a first initialization phase S11, a first data writing-in phase S12, and a first light emitting phase that are set successively. S13;

In the first initialization phase S11, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first An initial voltage Vini1 to the gate electrode of T0 and the anode of M1, so that at the beginning of the first data writing-in phase S12, T0 can be turned on, and the residual charge of the anode of M1 can be removed;

In the first initialization phase S11, T9 is turned off, T10 is turned off, and T12 is turned off;

In the first data writing-in phase S12, R1 provides a low voltage signal, R2 provides a high voltage signal, G1 provides a high voltage signal, G2 provides a low voltage signal, EM1 provides a high voltage signal, D1 provides a data voltage Vdata, and DT provides a high voltage signal, T10 is turned on to write Vdata into the source electrode of T0;

At the beginning of the first data writing-in phase S12, T0 is turned on, T9 is turned on, and C3 is charged by Vdata to change the potential of the gate electrode of T0 until T0 is turned off, and the potential of the gate electrode of T0 is related to the threshold voltage of T0;

In the first data writing-in phase S12, T8 and T11 are turned off, T12 is turned off, T1 is turned on, so as to control to connect DT to ch, the potential of ch is a high voltage, T3 is turned on, T2 is turned off, to control to connect EM1 and EM2;

In the first light emitting phase S13, R1 provides a low-voltage signal, R2 provides a high-voltage signal, G1 provides a low-voltage signal, G2 provides a high-voltage signal, EM1 provides a low-voltage signal, T12 is turned on, C1 maintains the potential of ch as a high voltage, and T2 is turned off, T3 is turned on to control the connection between EM1 and EM2, the potential of EM2 is a low-voltage signal, T4 is turned on, T0 drives M1 to emit light, and PAM emits light for a long time;

The second display period includes a second initialization phase S21, a second data writing-in phase S22, and a second light emitting phase S23, which are arranged successively;

In the second initialization phase S21, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first initial voltage Vini1 to the gate electrode of T0 and the anode of M1, so that at the beginning of the first data writing-in phase S12, T0 can be turned on, and the residual charge of the anode of M1 can be removed;

In the second initialization phase S21, T9 is turned off, T10 is turned off, and T12 is turned off;

In the second data writing-in phase S22, R1 provides a low voltage signal, R2 provides a high voltage signal, G1 provides a high voltage signal, G2 provides a low voltage signal, EM1 provides a high voltage signal, D1 provides a data voltage Vdata, and DT provides a low voltage signal, T10 is turned on to write Vdata into the source electrode of T0;

At the beginning of the second data writing-in phase S22, T0 is turned on, T9 is turned on, and C3 is charged by Vdata to change the potential of the gate electrode of T0 until T0 is turned off, and the gate potential of T0 is related to the threshold voltage of T0;

In the second data writing-in phase S22, T8 and T11 are turned off, T12 is turned off, T1 is turned on, so as to control to connect DT and ch, the potential of ch is a low voltage, T2 is turned on, T3 is turned off, to control to connect EM2 and HF;

In the second light emitting phase S23, R1 provides a low-voltage signal, R2 provides a high-voltage signal, G1 provides a low-voltage signal, G2 provides a high-voltage signal, EM1 provides a low-voltage signal, T12 is turned on, C1 maintains the potential of ch as a low voltage, and T2 is turned on, T3 is turned off, to control EM2 to connect to HF, when the voltage value of HF is low voltage, T4 is turned on, when T4 is turned on, T0 drives M1 to emit light for PWM high-frequency short-time light emitting, and low gray scale display.

As shown in FIG. 8, the pulse width of the first reset control signal provided by R1, the pulse width of the second reset control signal provided by R2, the pulse width of the first control signal provided by G1 and the pulse width of the second control signal provided by G2 can be the same, the pulse width of the data voltage provided by D1 is the same as the pulse width of the light emitting data voltage provided by DT, on the rising edge of the second control signal provided by G2, D1 provides the data voltage; on the falling edge of the first control signal provided by G1, DT provides the light emitting data voltage.

As shown in FIG. 8, when the first reset control signal provided by R1 is a high voltage, the second reset control signal provided by R2 is a low voltage, G1 provides a high voltage, and G2 provides a low voltage, the potential of HF is a high voltage.

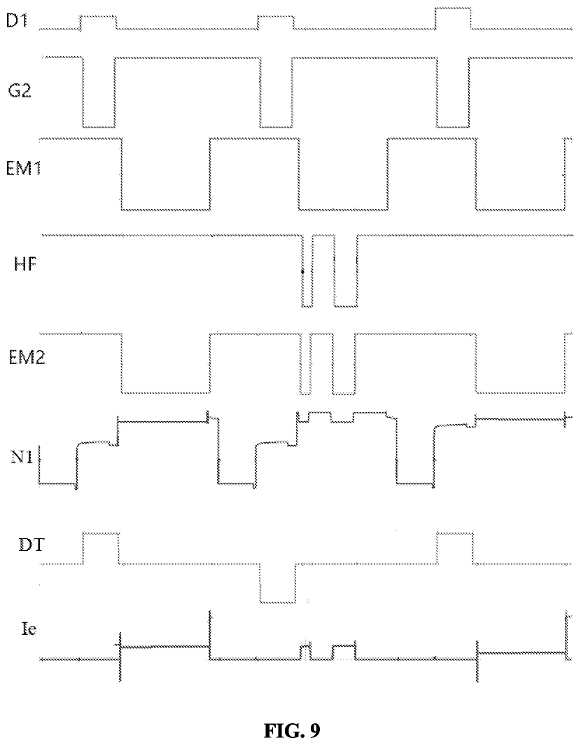

FIG. 9 is a working timing diagram of a simulation of the pixel circuit shown in FIG. 7A according to an embodiment of the present disclosure.

In FIG. 9, the one labeled Ie is the current flowing through M1.

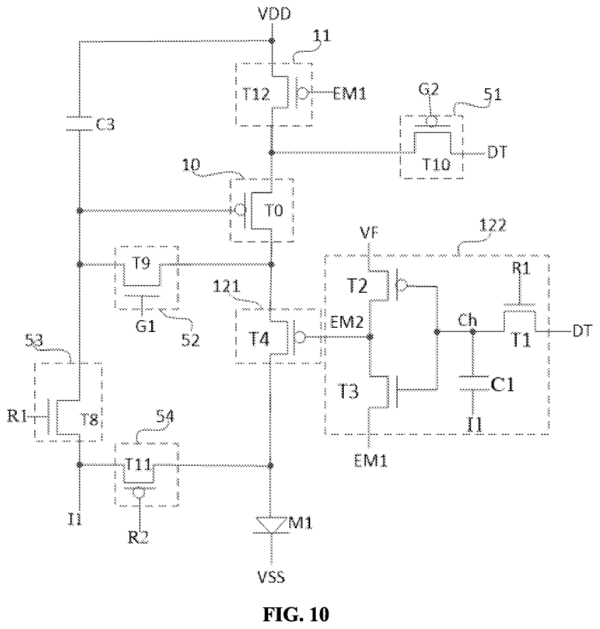

The difference between at least one embodiment of the pixel circuit shown in FIG. 10 of the present disclosure and at least one embodiment of the pixel circuit shown in FIG. 6 of the present disclosure is that the source electrode of T10 is electrically connected to DT, and the gate electrode of T1 is electrically connected to R1.

In at least one embodiment of the pixel circuit shown in FIG. 10 of the present disclosure, the data voltage and the light emitting data voltage can be combined into one voltage signal. At least one embodiment of the pixel circuit shown in FIG. 10 of the present disclosure is working, R1 first provides a high-voltage signal, and the light emitting data voltage provided by DT charges ch, and then G2 provides a low-voltage signal, T10 is turned on and the data voltage provided by DT charges C3.

As shown in FIG. 11, when at least one embodiment of the pixel circuit shown in FIG. 10 of the present disclosure is in operation, the first display period includes the first initialization phase S11, the first data writing-in phase S12, and the first light emitting phase that are set successively. S13;

In the first initialization phase S11, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first An initial voltage Vini1 to the gate electrode of T0 and the anode of M1, so that at the beginning of the first data writing-in phase S12, T0 can be turned on, and the residual charge of the anode of M1 can be cleared; T1 is turned on, DT provides the light emitting data voltage, the light emitting data voltage provided by DT is a high voltage, and C1 is charged by the light emitting data voltage, so that the potential of ch is the high voltage, T3 is turned on, and T2 is turned off, so as to control the connection between EM1 and EM2;

In the first initialization phase S11, T9 is turned off, T10 is turned off, and T12 is turned off;

In the first data writing-in phase S12, R1 provides a low voltage signal, R2 provides a high voltage signal, G1 provides a high voltage signal, G2 provides a low voltage signal, EM1 provides a high voltage signal, DT provides a data voltage Vdata, and T10 is turned on to write Vdata into the source electrode of T0, and T1 is turned off;

At the beginning of the first data writing-in phase S12, T0 is turned on, T9 is turned on, and C3 is charged by Vdata to change the potential of the gate electrode of T0 until T0 is turned off, and the potential of the gate electrode of T0 is related to the threshold voltage of T0;

In the first light emitting phase S13, R1 provides a low-voltage signal, R2 provides a high-voltage signal, G1 provides a low-voltage signal, G2 provides a high-voltage signal, EM1 provides a low-voltage signal, T12 is turned on, C1 maintains the potential of ch as a high voltage, and T2 is turned off, T3 is turned on to control the connection between EM1 and EM2, the potential of EM2 is a low-voltage signal, T4 is turned on, T0 drives M1 to emit light, for PAM long-time light emitting;

The second display period includes a second initialization phase S21, a second data writing-in phase S22, and a second light emitting phase S23, which are arranged successively;

In the second initialization phase S21, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first initial voltage Vini1 to the gate electrode of T0 and the anode of M1, so that at the beginning of the third writing-in period S221, T0 can be turned on, and the residual charge of the anode of M1 can be cleared; DT provides the light emitting data voltage, and the light emitting data voltage provided by DT is the low voltage, T8 and T11 are turned off, T12 is turned off, and T1 is turned on to control the connection between DT and ch, the potential of ch is the low voltage, T2 is turned on, and T3 is turned off to control EM2 to connect to HF;

In the second initialization phase S21, T9 is turned off, T10 is turned off, and T12 is turned off;

In the second data writing-in phase S22, R1 provides a low voltage signal, R2 provides a high voltage signal, G1 provides a high voltage signal, G2 provides a low voltage signal, EM1 provides a high voltage signal, DT provides a data voltage Vdata, and T10 is turned on to write Vdata into the source electrode of T0;

At the beginning of the second data writing-in phase S221, T0 is turned on, T9 is turned on, and C3 is charged by Vdata to change the potential of the gate electrode of T0 until T0 is turned off, and the potential of the gate electrode T0 is related to the threshold voltage of T0;

In the second light emitting phase S23, R1 provides a low-voltage signal, R2 provides a high-voltage signal, G1 provides a low-voltage signal, G2 provides a high-voltage signal, EM1 provides a low-voltage signal, T12 is turned on, C1 maintains the potential of ch as a low voltage, and T2 is turned on, T3 is turned off, to control EM2 to connect to HF, when the voltage value of HF is the low voltage, T4 is turned on, when T4 is turned on, T0 drives M1 to emit light for PWM high-frequency short-time light emitting, and low gray scale display.

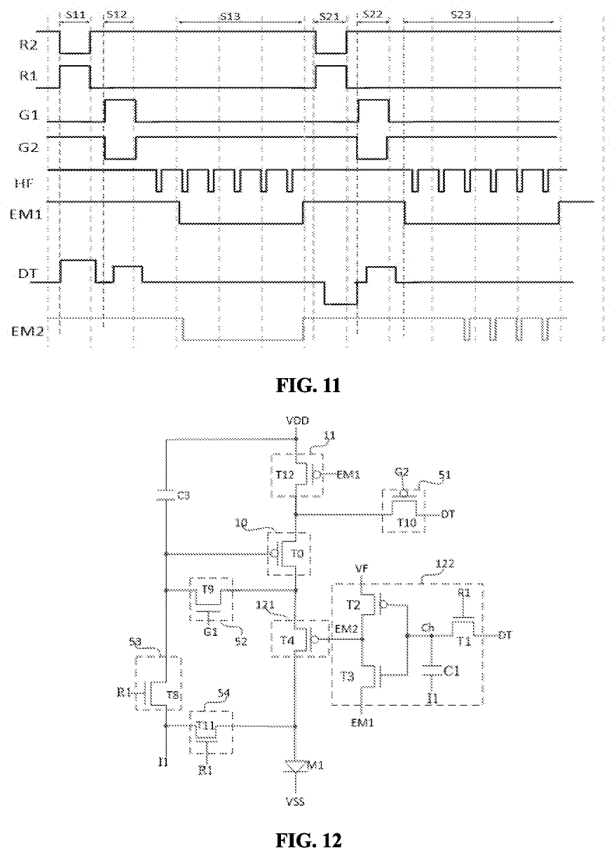

The difference between at least one embodiment of the pixel circuit shown in FIG. 12 of the present disclosure and at least one embodiment of the pixel circuit shown in FIG. 10 of the present disclosure is that T11 is an n-type transistor, and the gate electrode of T11 is electrically connected to R1.

In at least one embodiment of the pixel circuit shown in FIG. 12 of the present disclosure, T9, T8, and T11 are connected in series, and T9, T8, and T11 are all oxide thin film transistors, so the manufacturing process can be relatively simple.

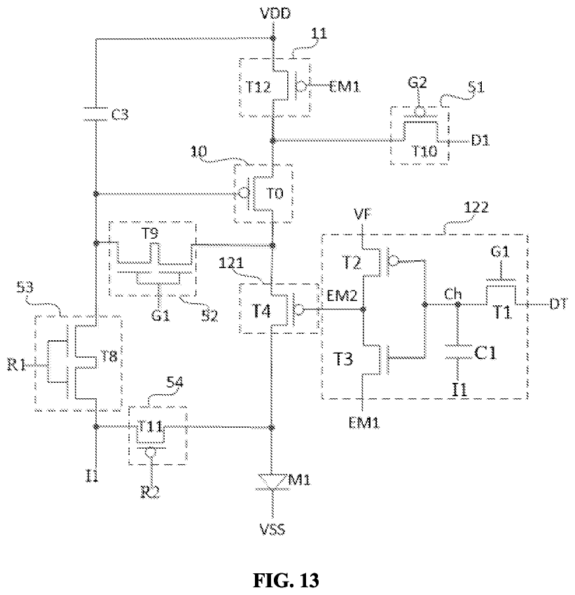

The difference between at least one embodiment of the pixel circuit shown in FIG. 13 of the present disclosure and at least one embodiment of the pixel circuit shown in FIG. 7A of the present disclosure is that both T8 and T9 are double-gate transistors to reduce leakage and facilitate maintenance of the potential of the gate electrode of T0; T8 and T9 are oxide thin film transistors.

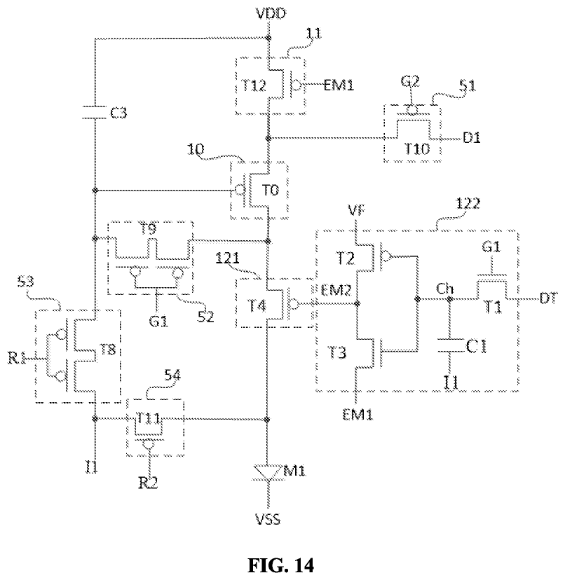

The difference between at least one embodiment of the pixel circuit shown in FIG. 14 of the present disclosure and at least one embodiment of the pixel circuit shown in FIG. 7A of the present disclosure is that both T8 and T9 are double-gate transistors to reduce leakage and facilitate maintenance of the potential of the gate electrode of T0; T8 and T9 are low temperature polysilicon thin film transistors.

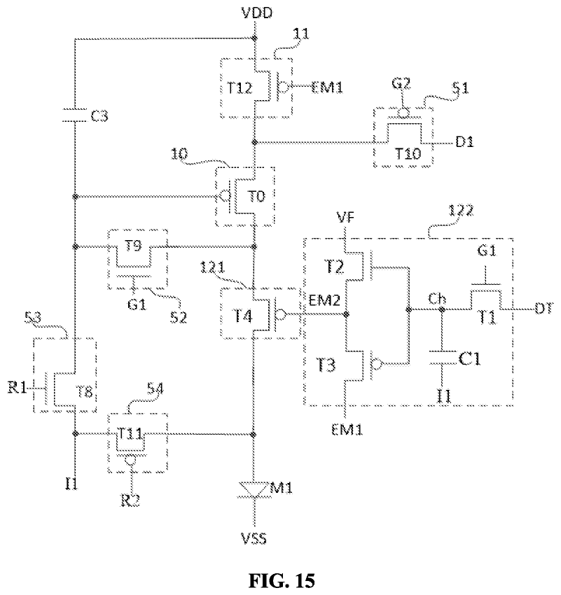

The difference between at least one embodiment of the pixel circuit shown in FIG. 15 of the present disclosure and at least one embodiment of the pixel circuit shown in FIG. 7A of the present disclosure is that: T2 is an n-type transistor, and T3 is a p-type transistor.

In at least one embodiment of the pixel circuit shown in FIG. 15, T8 may be replaced by a p-type transistor, T9 may be replaced by a p-type transistor, and T10 may be replaced by an n-type transistor, but not limited thereto.

As shown in FIG. 16, when at least one embodiment of the pixel circuit shown in FIG. 15 of the present disclosure is in operation, the first display period includes the first initialization phase S11, the first data writing-in phase S12, and the first light emitting phase S13 that are set successively;

In the first initialization phase S11, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first initial voltage Vini1 to the gate electrode of T0 and the anode of M1, so that at the beginning of the first data writing-in phase S12, T0 can be turned on, and the residual charge of the anode of M1 can be removed;

In the first initialization phase S11, T9 is turned off, T10 is turned off, and T12 is turned off;

In the first data writing-in phase S12, R1 provides a low voltage signal, R2 provides a high voltage signal, G1 provides a high voltage signal, G2 provides a low voltage signal, EM1 provides a high voltage signal, D1 provides a data voltage Vdata, and DT provides a low voltage signal, T10 is turned on to write Vdata into the source electrode of T0;

At the beginning of the first data writing-in phase S12, T0 is turned on, T9 is turned on, and C3 is charged by Vdata to change the potential of the gate electrode of T0 until T0 is turned off, and the potential of the gate electrode of T0 is related to the threshold voltage of T0;

In the first data writing-in phase S12, T8 and T11 are turned off, T12 is turned off, T1 is turned on, so as to control to connect DT to ch, the potential of ch is a low voltage, T3 is turned on, T2 is turned off, to control the connection between EM1 and EM2;

In the first light emitting phase S13, R1 provides a low-voltage signal, R2 provides a high-voltage signal, G1 provides a low-voltage signal, G2 provides a high-voltage signal, EM1 provides a low-voltage signal, T12 is turned on, C1 maintains the potential of ch as a low voltage, and T2 is turned off, T3 is turned on to control the connection between EM1 and EM2, the potential of EM2 is a low-voltage signal, T4 is turned on, T0 drives M1 to emit light, for PAM long time light emitting;

The second display period includes a second initialization phase S21, a second data writing-in phase S22, and a second light emitting phase S23, which are set successively;

In the second initialization phase S21, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first An initial voltage Vini1 to the gate electrode of T0 and the anode of M1, so that at the beginning of the first data writing-in phase S12, T0 can be turned on, and the residual charge of the anode of M1 can be removed;

In the second initialization phase S21, T9 is turned off, T10 is turned off, and T12 is turned off;

In the second data writing-in phase S22, R1 provides a low voltage signal, R2 provides a high voltage signal, G1 provides a high voltage signal, G2 provides a low voltage signal, EM1 provides a high voltage signal, D1 provides a data voltage Vdata, and DT provides a high voltage signal, T10 is turned on to write Vdata into the source electrode of T0;

At the beginning of the second data writing-in phase S22, T0 is turned on, T9 is turned on, and C3 is charged by Vdata to change the potential of the gate electrode of T0 until T0 is turned off, and the potential of the gate electrode of T0 is related to the threshold voltage of T0;

In the second data writing-in phase S22, T8 and T11 are turned off, T12 is turned off, T1 is turned on, so as to control to connect DT to ch, the potential of ch is a high voltage, T2 is turned on, and T3 is turned off, to control EM2 to connect to HF;

In the second light emitting phase S23, R1 provides a low-voltage signal, R2 provides a high-voltage signal, G1 provides a low-voltage signal, G2 provides a high-voltage signal, EM1 provides a low-voltage signal, T12 is turned on, C1 maintains the potential of ch as a high voltage, and T2 is turned on, T3 is turned off, to control EM2 to connect to HF, when the voltage value of HF is the low voltage, T4 is turned on, when T4 is turned on, T0 drives M1 to emit light for PWM high-frequency short-time light emitting, and low gray scale display.

When at least one embodiment of the pixel circuit shown in FIG. 15 of the present disclosure is working, when the potential of ch is low in the first data writing-in phase, T3 is turned on, after entering the first light emitting phase, the potential of ch needs to maintain the voltage value of the low voltage signal provided by DT (the voltage value can be −9V, for example) to ensure the on state of T3, and if the voltage value of the low voltage signal provided by G1 is −7V at this time, T1 is prone to reverse leakage, causing the potential of ch to rise, so it is necessary to adjust the voltage value of the low voltage signal provided by G1 to −12V to −9V (if it is necessary to completely turn of T1 so that ch has no reverse leakage, it is necessary to adjust the voltage value of the low voltage signal provided by G1 to be reduced to −12V, but it can also be reduced to −9V in order to meet the demand).

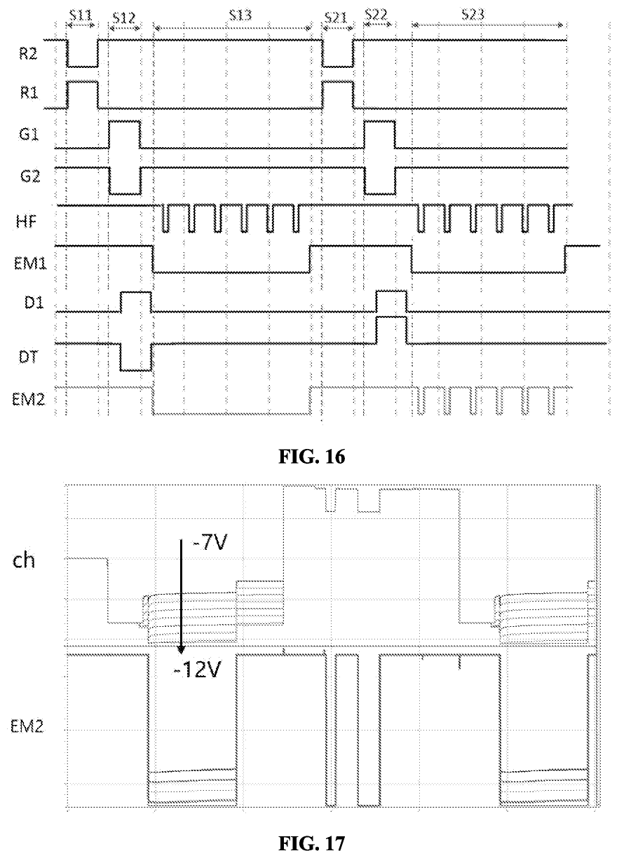

As shown in FIG. 17, when at least one embodiment of the pixel circuit shown in FIG. 15 of the present disclosure is working, when the potential of ch is lower, the potential of EM2 is lower.

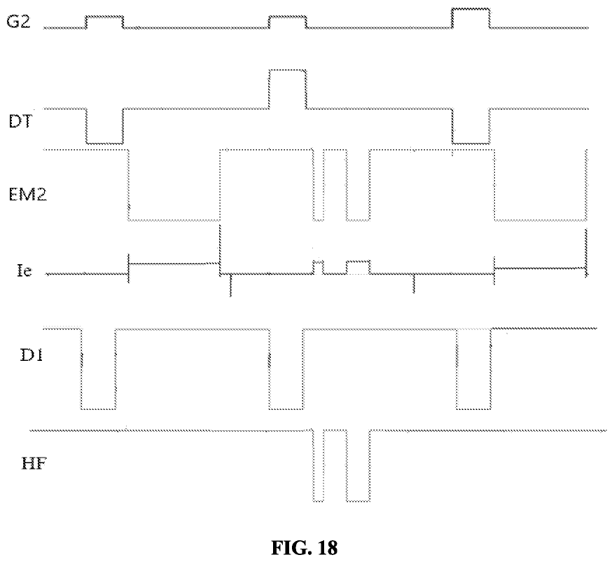

FIG. 18 is a working timing diagram of a simulation of the pixel circuit shown in FIG. 15 according to at least one embodiment of the present disclosure.

In FIG. 9 and FIG. 18, the one labeled Ie is the current flowing through M1.

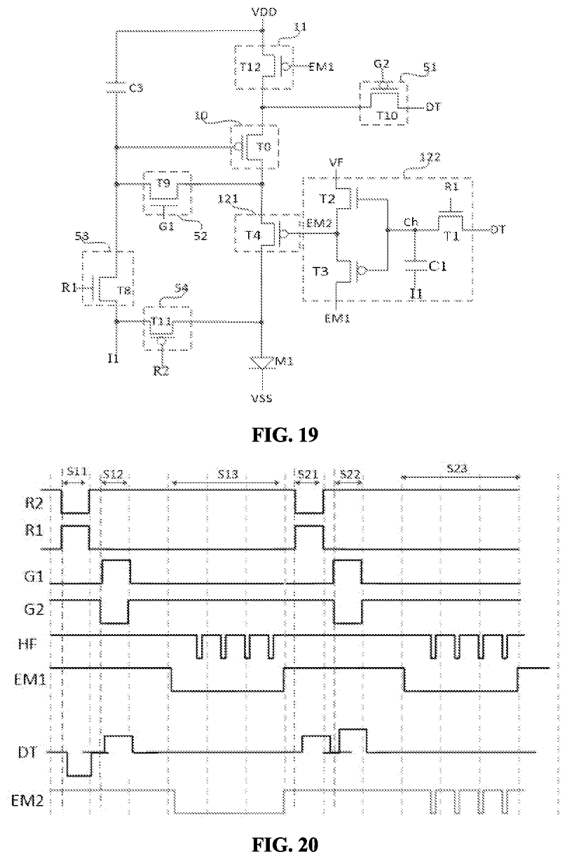

The difference between at least one embodiment of the pixel circuit shown in FIG. 19 of the present disclosure and at least one embodiment of the pixel circuit shown in FIG. 15 of the present disclosure is that the source electrode of T10 is electrically connected to DT, and the gate electrode of T1 is electrically connected to R1.

In at least one embodiment of the pixel circuit shown in FIG. 19 of the present disclosure, the data voltage and the light emitting data voltage can be combined into one voltage signal.

As shown in FIG. 20, when at least one embodiment of the pixel circuit shown in FIG. 19 of the present disclosure is in operation, the first display period includes the first initialization phase S11, the first data writing-in phase S12, and the first light emitting phase S13 that are set successively;

In the first initialization phase S11, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first An initial voltage Vini1 to the gate electrode of T0 and the anode of M1, so that at the beginning of the first data writing-in phase S121, T0 can be turned on, and the residual charge of the anode of M1 can be removed;

In the first initialization phase S11, T9 is turned off, T10 is turned off, and T12 is turned off;

In the first initialization phase S11, T1 is turned on, DT provides the light emitting data voltage, and the light emitting data voltage provided by DT is a low voltage, T8 and T11 are turned off, T12 is turned off, and T1 is turned on, so as to control the connection between DT and ch, the potential of ch is the low voltage, T3 is turned on, and T2 is turned off to control the connection between EM1 and EM2;

In the first data writing-in phase S12, R1 provides a low voltage signal, R2 provides a high voltage signal, G1 provides a low voltage signal, G2 provides a low voltage signal, EM1 provides a high voltage signal, DT provides a data voltage Vdata, and T10 is turned on to write Vdata into the source electrode of T0, and T1 is turned off;

At the beginning of the first data writing-in phase S12, T0 is turned on, T9 is turned on, and C3 is charged by Vdata to change the potential of the gate electrode of T0 until T0 is turned off, and the potential of the gate electrode of T0 is related to the threshold voltage of T0;

In the first light emitting phase S13, R1 provides a low-voltage signal, R2 provides a high-voltage signal, G1 provides a low-voltage signal, G2 provides a high-voltage signal, EM1 provides a low-voltage signal, T12 is turned on, C1 maintains the potential of ch as a high voltage, and T2 is turned off, T3 is turned on to control the connection between EM1 and EM2, the potential of EM2 is a low-voltage signal, T4 is turned on, T0 drives M1 to emit light, and for PAM long time light emitting;

The second display period includes a second initialization phase S21, a second data writing-in phase S22, and a second light emitting phase S23, which are set successively;

In the second initialization phase S21, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first initial voltage Vini1 to the gate electrode of T0 and the anode of M1, so that at the beginning of the third writing-in phase S221, T0 can be turned on, and the residual charge of the anode of M1 can be removed;

In the second initialization phase S21, T9 is turned off, T10 is turned off, and T12 is turned off;

In the second initialization phase S21, T1 is turned on, DT provides the light emitting data voltage, and the light emitting data voltage provided by DT is a high voltage, T8 and T11 are turned off, T12 is turned off, and T1 is turned on, so as to control the connection between DT and ch, the potential of ch is a high voltage, T2 is turned on, and T3 is turned off, so as to control EM2 to connect to HF;

In the second data writing-in phase S22, R1 provides a low voltage signal, R2 provides a high voltage signal, G1 provides a low voltage signal, G2 provides a low voltage signal, EM1 provides a high voltage signal, DT provides a data voltage Vdata, and T10 is turned on to write Vdata into the source electrode of T0;

At the beginning of the second data writing-in phase S22, T0 is turned on, T9 is turned on, and C3 is charged by Vdata to change the potential of the gate electrode of T0 until T0 is turned off, and the potential of the gate electrode of T0 is related to the threshold voltage of T0;

In the second light emitting phase S23, R1 provides a low-voltage signal, R2 provides a high-voltage signal, G1 provides a low-voltage signal, G2 provides a high-voltage signal, EM1 provides a low-voltage signal, T12 is turned on, C1 maintains the potential of ch as a low voltage, and T2 is turned on, T3 is turned off, to control EM2 to connect to HF, when the voltage value of HF is the low voltage, T4 is turned on, when T4 is turned on, T0 drives M1 to emit light for PWM high-frequency short-time light emitting, and low gray scale display.

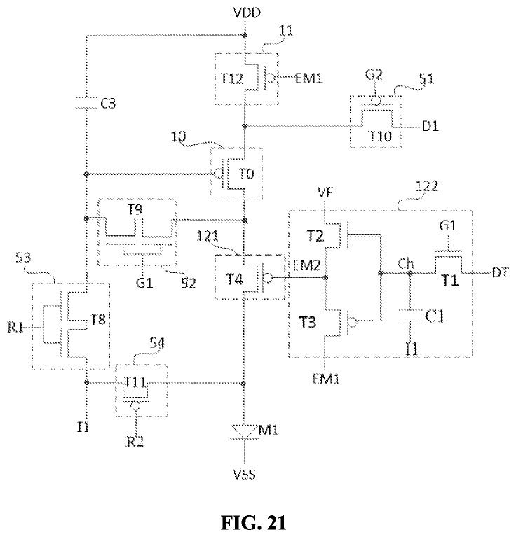

The difference between at least one embodiment of the pixel circuit shown in FIG. 21 of the present disclosure and at least one embodiment of the pixel circuit shown in FIG. 15 of the present disclosure is that both T8 and T9 are double-gate transistors to reduce leakage and facilitate maintenance the potential of the gate electrode of T0; T8 and T9 are oxide thin film transistors.

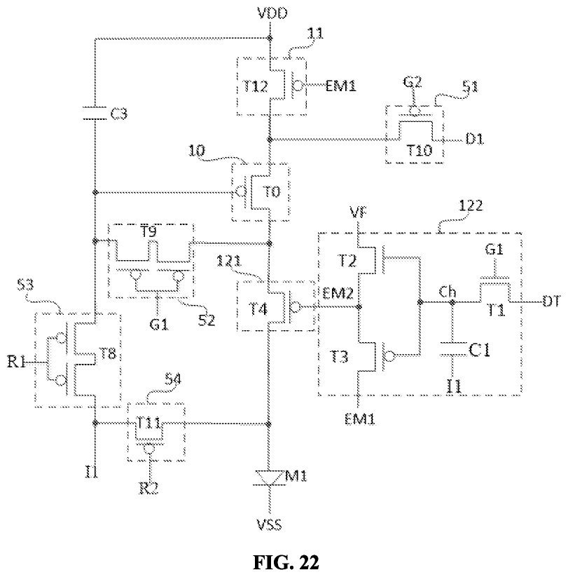

The difference between at least one embodiment of the pixel circuit shown in FIG. 22 of the present disclosure and at least one embodiment of the pixel circuit shown in FIG. 15 of the present disclosure is that both T8 and T9 are double-gate transistors to reduce leakage and facilitate maintenance of the potential of the gate electrode of T0; T8 and T9 are low temperature polysilicon thin film transistors.

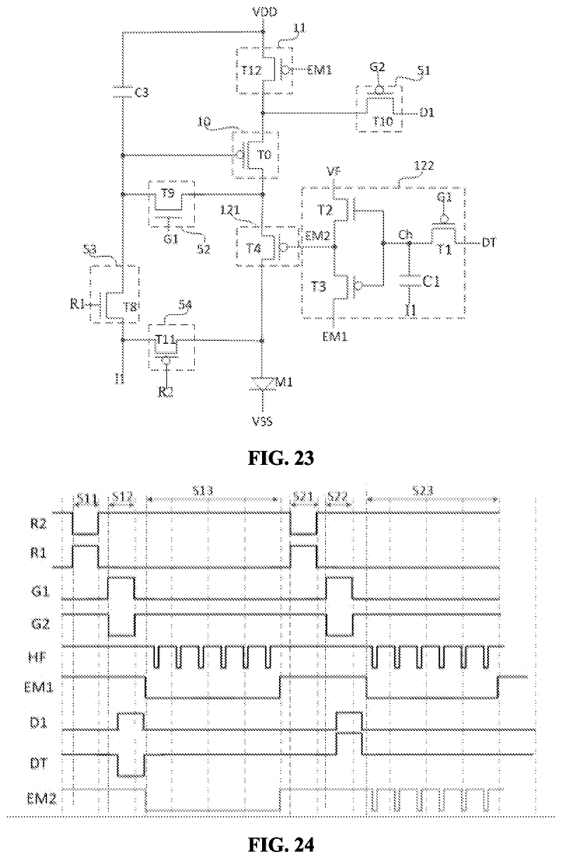

The difference between at least one embodiment of the pixel circuit shown in FIG. 23 of the present disclosure and at least one embodiment of the pixel circuit shown in FIG. 15 of the present disclosure is that T1 is a p-type transistor;

The gate electrode of T1 is electrically connected to the second control terminal G2.

In at least one embodiment of the pixel circuit shown in FIG. 23, the first control terminal and the second control terminal are the same control terminal, and the gate electrode of T0 and the gating control terminal ch are charged simultaneously through D1 and DT respectively.

In at least one embodiment of the pixel circuit shown in FIG. 23, T8 can be replaced by a p-type transistor, T9 can be replaced by a p-type transistor, and T10 can be replaced by an n-type transistor, but not limited thereto.

As shown in FIG. 24, when at least one embodiment of the pixel circuit shown in FIG. 23 of the present disclosure is in operation, the first display period includes the first initialization phase S11, the first data writing-in phase S12, and the first light emitting phase S13 that are set successively;

In the first initialization phase S11, R1 provides a high voltage signal, R2 provides a low voltage signal, G2 provides a high voltage signal, EM1 provides a high voltage signal, T8 and T11 are turned on, and the first initial voltage terminal I1 provides the first initial voltage Vini1 to the gate electrode of T0 and the anode of M1, so that at the beginning of the first data writing-in phase S12, T0 can be turned on, and the residual charge of the anode of M1 is removed;

In the first initialization phase S11, T9 is turned off, T10 is turned off, and T12 is turned off;

In the first data writing-in phase S12, R1 provides a low voltage signal, R2 provides a high voltage signal, G2 provides a low voltage signal, EM1 provides a high voltage signal, D1 provides a data voltage Vdata, DT provides a low voltage signal, and T10 is turned on to write Vdata into the source electrode of T0;

At the beginning of the first data writing-in phase S12, T0 is turned on, T9 is turned on, and C3 is charged by Vdata to change the potential of the gate electrode of T0 until T0 is turned off, and the potential of the gate electrode of T0 is related to the threshold voltage of T0;

In the first data writing-in phase S12, T8 and T11 are turned off, T12 is turned off, T1 is turned on, so as to control to connect DT and ch, the potential of ch is a low voltage, T3 is turned on, T2 is turned off, to control the connection between EM1 and EM2;

In the first light emitting phase S13, R1 provides a low-voltage signal, R2 provides a high-voltage signal, G2 provides a high-voltage signal, EM1 provides a low-voltage signal, T12 is turned on, C1 maintains the potential of ch at a low voltage, T2 is turned off, and T3 is turned on, to control the connection between EM1 and EM2, the potential of EM2 is a low-voltage signal, T4 is turned on, and T0 drives M1 to emit light for PAM long time light emitting;

The second display period includes a second initialization phase S21, a second data writing-in phase S22, and a second light emitting phase S23, which are set successively;

In the second initialization phase S21, R1 provides a high voltage signal, R2 provides a low voltage signal, G2 provides a high voltage signal, EM1 provides a high voltage signal, T8 and T11 are turned on, and the first initial voltage terminal I1 provides the first initial voltage Vini1 to the gate electrode of T0 and the anode of M1, so that at the beginning of the first data writing-in phase S12, T0 can be turned on, and the residual charge of the anode of M1 is removed;

In the second initialization phase S21, T9 is turned off, T10 is turned off, and T12 is turned off;

In the second data writing-in phase S22, R1 provides a low voltage signal, R2 provides a high voltage signal, G2 provides a low voltage signal, EM1 provides a high voltage signal, D1 provides a data voltage Vdata, DT provides a high voltage signal, and T10 is turned on to write Vdata into the source electrode of T0;

At the beginning of the second data writing-in phase S22, T0 is turned on, T9 is turned on, and C3 is charged by Vdata to change the potential of the gate electrode of T0 until T0 is turned off, and the potential of the gate electrode of T0 is related to the threshold voltage of T0;

In the second data writing-in phase S22, T8 and T11 are turned off, T12 is turned off, T1 is turned on, so as to control to connect DT and ch, the potential of ch is a high voltage, T2 is turned on, and T3 is turned off, to control EM2 to connect to HF;

In the second light emitting phase S23, R1 provides a low-voltage signal, R2 provides a high-voltage signal, G2 provides a high-voltage signal, EM1 provides a low-voltage signal, T12 is turned on, C1 maintains the potential of ch as a high voltage, T2 is turned on, and T3 is turned off, to control EM2 to connect to HF, when the voltage value of HF is the low voltage, T4 is turned on, and when T4 is turned on, T0 drives M1 to emit light to perform PWM high-frequency short-term light emitting and low gray scale display.

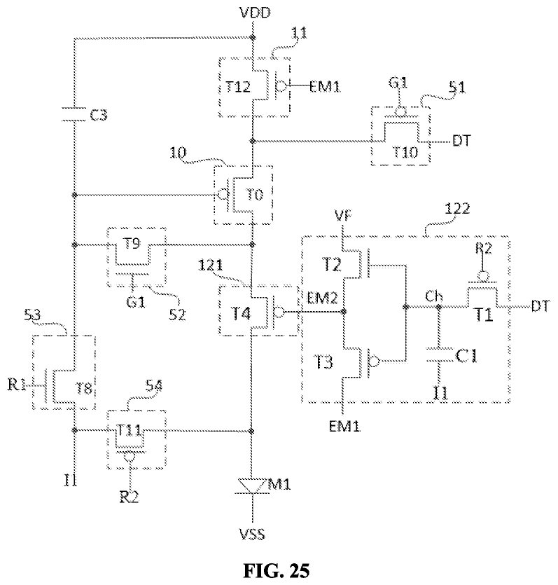

The difference between at least one embodiment of the pixel circuit shown in FIG. 25 of the present disclosure and at least one embodiment of the pixel circuit shown in FIG. 23 of the present disclosure is that: the gate electrode of T1 is electrically connected to R2; the source electrode of T10 is electrically connected to DT.

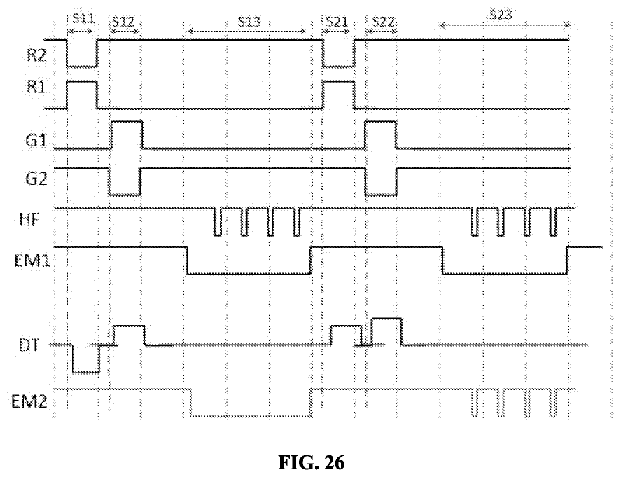

As shown in FIG. 26, when at least one embodiment of the pixel circuit shown in FIG. 25 of the present disclosure is in operation, the first display period includes the first initialization phase S11, the first data writing-in phase S12 and the first light emitting phase S13 which are set successively.;

In the first initialization phase S11, R1 provides a high-voltage signal, R2 provides a low-voltage signal, G1 provides a high-voltage signal, G2 provides a high-voltage signal, EM1 provides a high-voltage signal, T8 and T11 are turned on, and the first initial voltage terminal I1 provides the first An initial voltage Vini1 to the gate electrode of T0 and the anode of M1, so that at the beginning of the first data writing-in phase S12, T0 can be turned on, and the residual charge of the anode of M1 can be removed;

In the first initialization phase S11, DT provides the light emitting data voltage, the light emitting data voltage provided by DT is a low voltage, T8 and T11 are turned off, T12 is turned off, T1 is turned on, so as to control the connection between DT and ch, the potential of ch is a low voltage, T3 is turned on, and T2 is turned off to control the connection between EM1 and EM2;

In the first initialization phase S11, T9 is turned off, T10 is turned off, and T12 is turned off;

In the first data writing-in phase S12, R1 provides a low voltage signal, R2 provides a high voltage signal, G1 provides a high voltage signal, G2 provides a low voltage signal, EM1 provides a high voltage signal, DT provides a data voltage Vdata, and T10 is turned on to write Vdata into the source electrode of T0, and T1 is turned off;

At the beginning of the first data writing-in phase S12, T0 is turned on, T9 is turned on, and C3 is charged by Vdata to change the potential of the gate electrode of T0 until T0 is turned off, and the potential of the gate electrode of T0 is related to the threshold voltage of T0;

In the first light emitting phase S13, R1 provides a low-voltage signal, R2 provides a high-voltage signal, G1 provides a high-voltage signal, G2 provides a high-voltage signal, EM1 provides a low-voltage signal, T12 is turned on, C1 maintains the potential of ch as a high voltage, and T2 is turned off, T3 is turned on to control the connection between EM1 and EM2, the potential of EM2 is a low-voltage signal, T4 is turned on, T0 drives M1 to emit light, and for PAM long time light emitting;

The second display period includes a second initialization phase S21, a second data writing-in phase S22, and a second light emitting phase S23, which are set successively;

In the second initialization phase S21, R1 provides a high-voltage signal, R2 provides a low-voltage signal, G1 provides a high-voltage signal, G2 provides a high-voltage signal, EM1 provides a high-voltage signal, T8 and T11 are turned on, and the first initial voltage terminal I1 provides the first An initial voltage Vini1 to the gate electrode of T0 and the anode of M1, so that at the beginning of the third writing-in period S221, T0 can be turned on, and the residual charge of the anode of M1 can be removed;

In the second initialization phase S21, T9 is turned off, T10 is turned off, and T12 is turned off;

In the second initialization phase S21, DT provides the light emitting data voltage, the light emitting data voltage provided by DT is a high voltage, T8 and T11 are turned off, T12 is turned off, T1 is turned on, so as to control the connection between DT and ch, the potential of ch is a high voltage, T2 is turned on, and T3 is turned off, so as to control EM2 to connect to HF;

In the second data writing-in phase S22, R1 provides a low voltage signal, R2 provides a high voltage signal, G1 provides a high voltage signal, G2 provides a low voltage signal, EM1 provides a high voltage signal, DT provides a data voltage Vdata, and T10 is turned on to write Vdata into the source electrode of T0;

At the beginning of the second data writing-in phase S22, T0 is turned on, T9 is turned on, and C3 is charged by Vdata to change the potential of the gate electrode of T0 until T0 is turned off, and the potential of the gate electrode of T0 is related to the threshold voltage of T0;

In the second light emitting phase S23, R1 provides a low-voltage signal, R2 provides a high-voltage signal, G1 provides a high-voltage signal, G2 provides a high-voltage signal, EM1 provides a low-voltage signal, T12 is turned on, C1 maintains the potential of ch as a low voltage, and T2 is turned on, T3 is turned off, to control EM2 to connect to HF, when the voltage value of HF is the low voltage, T4 is turned on, when T4 is turned on, T0 drives M1 to emit light for PWM high-frequency short-time light emitting, and low gray scale display.

In at least one embodiment of the pixel circuit described in the present disclosure, the capacitance value of C1 electrically connected to the drain electrode of T1 can be reduced, or C1 can be removed, which is beneficial to achieve high Pixels Per Inch (PPI, pixel density).

In at least one embodiment of the present disclosure, when T1 is an n-type transistor, T2 is a p-type transistor, and T3 is an n-type transistor, the voltage value of the low voltage signal provided by the first initial voltage Vini1 and VSS may be −2V, the voltage value of the high voltage signal provided by VDD can be 8V, the high voltage value of the first control signal provided by G1 can be 7V, the low voltage value of the first control signal provided by G1 can be −9V; the high voltage value of the first light emitting control signal provided by EM1 can be 7V, the low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 5V, the low voltage value of the light emitting data voltage provided by DT can be −8V, and in the light emitting phase, DT can provide 0V voltage signal, but not limited to.

In at least one embodiment of the present disclosure, when T1 is an n-type transistor, T2 is an n-type transistor, and T3 is a p-type transistor, the voltage value of the low voltage signal provided by the first initial voltage Vini1 and VSS may be −2V, the voltage value of the high voltage signal provided by VDD can be 8V, the high voltage value of the first control signal provided by G1 can be 10V, the low voltage value of the first control signal provided by G1 can be −12V; the high voltage value of the first light emitting control signal provided by EM1 can be 7V, the low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 9V, the low voltage value of the light emitting data voltage provided by DT can be −8V, and in the light emitting phase, DT can provide 0V voltage signal, but not limited to.

In at least one embodiment of the present disclosure, when T1 is a p-type transistor, T2 is an n-type transistor, and T3 is a p-type transistor, the voltage value of the low voltage signal provided by the first initial voltage Vini1 and VSS may be −2V, the voltage value of the high voltage signal provided by VDD can be 8V, the high voltage value of the first control signal provided by G1 can be 10V, the low voltage value of the first control signal provided by G1 can be −7V; the high voltage value of the first light emitting control signal provided by EM1 can be 7V, the low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 9V, the low voltage value of the light emitting data voltage provided by DT can be −7V, and in the light emitting phase, DT can provide 0V voltage signal, but not limited to.

In specific implementation, when the light emitting data voltage provided by DT needs to be a positive value,

In at least one embodiment of the present disclosure, when T1 is an n-type transistor, T2 is a p-type transistor, and T3 is an n-type transistor, the voltage value of the low voltage signal provided by the first initial voltage Vini1 and VSS may be −2V, the voltage value of the high voltage signal provided by VDD can be 8V, the high voltage value of the first control signal provided by G1 can be 15V, the low voltage value of the first control signal provided by G1 can be −1V; the high voltage value of the first light emitting control signal provided by EM1 can be 15V, the low voltage value of the first light emitting control signal provided by EM1 can be 1V, the high voltage value of HF can be 15V, the low voltage value of HF can be 1V, and the voltage value of the data voltage provided by D1 can be greater than or equal to 12V and less than or equal to 14V, the high voltage value of the light emitting data voltage provided by DT can be 13V, and the low voltage value of the light emitting data voltage provided by DT can be 0V, but not limited thereto.

In specific implementation, when the light emitting data voltage provided by DT needs to be a positive value,

In at least one embodiment of the present disclosure, when T1 is an n-type transistor, T2 is an n-type transistor, and T3 is a p-type transistor, the voltage value of the low voltage signal provided by the first initial voltage Vini1 and VSS may be −2V, the voltage value of the high voltage signal provided by VDD can be 8V, the high voltage value of the first control signal provided by G1 can be 18V, the low voltage value of the first control signal provided by G1 can be −4V; the high voltage value of the first light emitting control signal provided by EM1 can be 15V, the low voltage value of the first light emitting control signal provided by EM1 can be 1V, the high voltage value of HF can be 15V, the low voltage value of HF can be 1V, and the voltage value of the data voltage provided by D1 can be greater than or equal to 12V and less than or equal to 14V, the high voltage value of the light emitting data voltage provided by DT can be 17V, and the low voltage value of the light emitting data voltage provided by DT can be 0V, but not limited thereto.

In specific implementation, when the light emitting data voltage provided by DT needs to be a positive value,

When T1 is a p-type transistor, T2 is an n-type transistor, and T3 is a p-type transistor, the voltage value of the low-voltage signal provided by the first initial voltage Vini1 and VSS can be −2V, and the voltage value of the high-voltage signal provided by VDD can be 8V, the high voltage value of the first control signal provided by G1 can be 17V, the low voltage value of the first control signal provided by G1 can be 0V; the high voltage value of the first light emitting control signal provided by EM1 can be 15V, the low voltage value of the first light emitting control signal provided by EM1 may be 1V, the high voltage value of HF may be 15V, the low voltage value of HF may be 1V, and the voltage value of the data voltage provided by D1 may be greater than or equal to 12V and less than or equal to 14V, the high voltage value of the light emitting data voltage provided by DT may be 16V, and the low voltage value of the light emitting data voltage provided by DT may be 0V, but not limited thereto.

In at least one embodiment of the present disclosure, when T1 is an n-type transistor, T2 is a p-type transistor, and T3 is an n-type transistor,

In PWM dimming mode, in the low-voltage maintenance phase of ch, T1 needs a lower turn-off voltage, so the low voltage value of the first control signal provided by G1 needs to be lowered;

In the PAM dimming mode, the high voltage of HF can be used to replace the high voltage of EM1 to enter EM2, which is beneficial to reduce the high voltage value of the first control signal provided by G1 and the high voltage value of the light emitting data voltage provided by DT.

In at least one embodiment of the present disclosure, when T1 is an n-type transistor, T2 is an n-type transistor, and T3 is a p-type transistor,

When the light emitting data voltage provided by DT is a low voltage, it is necessary to turn on T3 so that the low voltage signal provided by EM1 passes through;

When the light emitting data voltage provided by DT is a high voltage, it is necessary to turn on T2 so that the high voltage of HF passes through, so the high and low voltage span of the light emitting data voltage provided by DT is relatively large;

The requirement for the high voltage value of the first control signal provided by G1 is also large. At the same time, in the low voltage maintenance phase of ch, the low voltage value of the first control signal provided by G1 needs to be lower to turn off T1, so the high and low voltage span of the first control signal provided by G1 is relatively large.

In at least one embodiment of the present disclosure, when T1 is a p-type transistor, T2 is an n-type transistor, and T3 is a p-type transistor,

In PWM dimming mode, T1 needs a higher turn-off voltage during the high-voltage maintenance phase of ch;
the turn-off voltage of the first control signal provided by G1 is increased so that the stress on T1 is large during the PAM light emitting phase.

In at least one embodiment of the present disclosure, the light emitting gating circuit includes a second gating control circuit, a third light emitting control circuit, and a fourth light emitting control circuit;

The second gating control circuit is electrically connected to the first control terminal, the light emitting data voltage terminal, and the gating control terminal, and is configured to control to write the light emitting data voltage into the gating control terminal under the control of the first control signal;

The third light emitting control circuit is electrically connected to the gating control terminal, the second electrode of the light emitting element and the second voltage terminal, and is configured to control to connect the second electrode of the light emitting element and the second voltage terminal under the control of the potential of the gating control terminal;

The fourth light emitting control circuit is electrically connected to the light emitting control voltage terminal, the second electrode of the light emitting element and the second voltage terminal respectively, and is configured to control to connect the second electrode of the light emitting element and the second voltage terminal under the control of the light emitting control voltage provided by the light emitting control voltage terminal.

When the pixel circuit described in at least one embodiment of the present disclosure is working, the second gating control circuit writes the light emitting data voltage into the gating control terminal under the control of the first control signal, when in the light emitting phase, the third light emitting control circuit controls to connect the second electrode of the light emitting element and the second voltage terminal under the control of the potential of the gating control terminal, so as to realize the PAM long-time light emitting; when in the light emitting phase, the fourth light emitting control circuit realizes high-frequency short-time light emitting and low-gray-scale display under the control of light emitting control voltage (the light emitting control voltage is a high-frequency PWM signal).

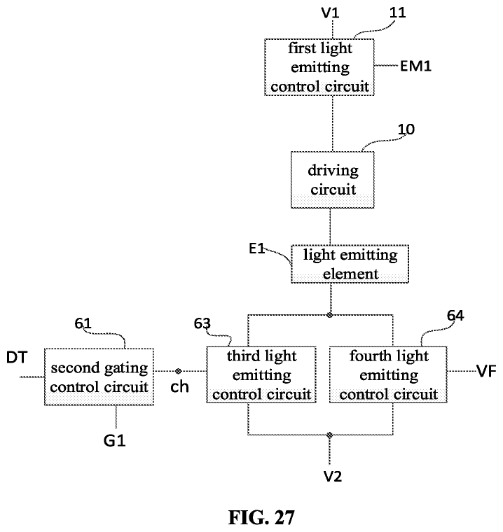

As shown in FIG. 27, the pixel circuit described in at least one embodiment of the present disclosure includes a first light emitting control circuit 11, a light emitting element E1, a driving circuit 10, and a light emitting gating circuit;

The first light emitting control circuit 11 is electrically connected to the first light emitting control terminal EM1, the first voltage terminal V1 and the first terminal of the driving circuit 10 respectively, and is configured to control to connect the first voltage terminal V1 and the first terminal of the driving circuit 10 under the control of the first light emitting control signal provided by the first light emitting control terminal EM1 during the light emitting phase;

The second terminal of the driving circuit 10 is electrically connected to the first electrode of the light emitting element E1, and the driving circuit 10 is configured to drive the light emitting element E1;

The light emitting gating circuit includes a second gating control circuit 61, a third light emitting control circuit 63 and a fourth light emitting control circuit 64;

The second gating control circuit 61 is electrically connected to the first control terminal G1, the light emitting data voltage terminal DT and the gating control terminal ch respectively, and is configured to write the light emitting data voltage provided by the light emitting data voltage terminal DT into the gating control terminal ch under the control of the first control signal provided by the first control terminal G1;

The third light emitting control circuit 63 is electrically connected to the gating control terminal ch, the second electrode of the light emitting element E1 and the second voltage terminal V2 respectively, and is configured to control to connect the second electrode of the light emitting element E1 and the second voltage terminal V2 under the control of the potential of the gating control terminal ch;

The fourth light emitting control circuit 64 is electrically connected to the light emitting control voltage terminal VF, the second electrode of the light emitting element E1 and the second voltage terminal V2 respectively, and is configured to control to connect the second electrode of the light emitting element E1 and the second voltage terminal V2 under the control of the light emitting control voltage HF provided by the light emitting control voltage terminal VF.

In at least one embodiment of the present disclosure, the first voltage terminal may be a high voltage terminal, and the second voltage terminal may be a low voltage terminal, but not limited thereto.

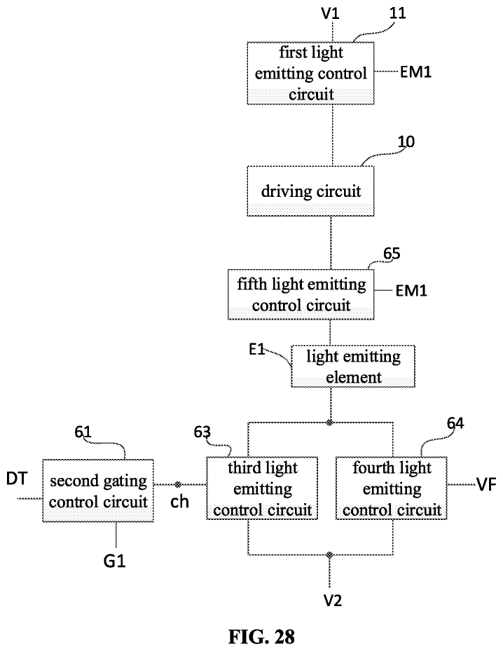

As shown in FIG. 28, on the basis of at least one embodiment of the pixel circuit shown in FIG. 27, the pixel circuit described in at least one embodiment of the present disclosure may further include a fifth light emitting control circuit 65;

The fifth light emitting control circuit 65 is electrically connected to the first light emitting control terminal EM1, the second terminal of the driving circuit 10 and the first electrode of the light emitting element E1 respectively, and is configured to control to connect the second terminal of the driving circuit 10 and the first electrode of the light emitting element E1 under the control of the first light emitting control signal.

Optionally, the light emitting gating circuit further includes a second capacitor;

A first terminal of the second capacitor is electrically connected to the gating control terminal, a second terminal of the second capacitor is electrically connected to the first initial voltage terminal, and the second capacitor can be configured to maintain the potential at the gating control terminal.

Optionally, the second gating control circuit includes a fifth transistor, the third light emitting control circuit includes a sixth transistor, and the fourth light emitting control circuit includes a seventh transistor;

A control electrode of the fifth transistor is electrically connected to the first control terminal, a first electrode of the fifth transistor is electrically connected to the light emitting data voltage terminal, and a second electrode of the fifth transistor is electrically connected to the gating control terminal;

A control electrode of the sixth transistor is electrically connected to the gating control terminal, a first electrode of the sixth transistor is electrically connected to the second electrode of the light emitting element, a second electrode of the sixth transistor is electrically connected to the second voltage terminal;

A control electrode of the seventh transistor is electrically connected to the light emitting control voltage terminal, a first electrode of the seventh transistor is electrically connected to the second electrode of the light emitting element, and a second electrode of the seventh transistor is electrically connected to the second voltage terminal.

Optionally, the seventh transistor is a p-type transistor, the sixth transistor is an n-type transistor, and the fifth transistor is an n-type transistor; or,

The seventh transistor is a p-type transistor, the sixth transistor is an n-type transistor, and the fifth transistor is a p-type transistor; or,

The seventh transistor is an n-type transistor, the sixth transistor is a p-type transistor, and the fifth transistor is an n-type transistor; or,

The seventh transistor is an n-type transistor, the sixth transistor is a p-type transistor, and the fifth transistor is a p-type transistor.

Optionally, the fifth light emitting control circuit may include a thirteenth transistor;

A control electrode of the thirteenth transistor is electrically connected to the first light emitting control terminal, a first electrode of the thirteenth transistor is electrically connected to the second terminal of the driving circuit, and a second electrode of the thirteenth transistor is electrically connected to the first electrode of the light emitting element.

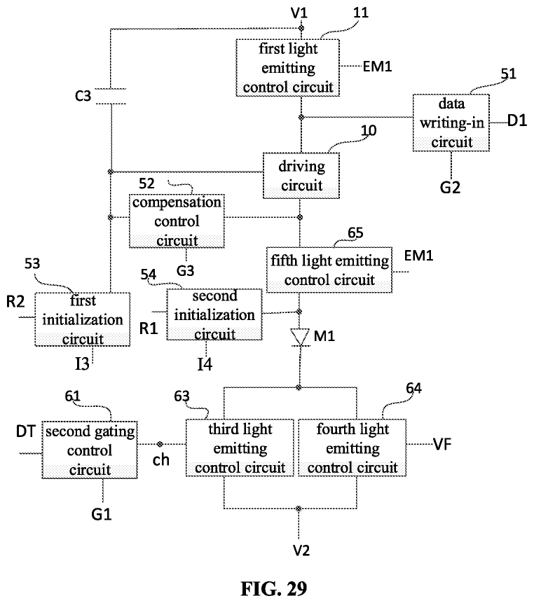

As shown in FIG. 29, on the basis of at least one embodiment of the pixel circuit shown in FIG. 28, the pixel circuit described in at least one embodiment of the present disclosure may further include a data writing-in circuit 51, a compensation control circuit 52, a first initialization circuit 53, a second initialization circuit 54, and a third capacitor C3; the light emitting element is a miniature light emitting diode M1;

The data writing-in circuit 51 is electrically connected to the second control terminal G2, the data line D1 and the first terminal of the driving circuit 10 respectively, and is configured to write the data voltage Vdata provided by the data line D1 into the first terminal of the driving circuit 10 under the control of the second control signal provided by the second control terminal G2;

The compensation control circuit 52 is electrically connected to the third control terminal G3, the control terminal of the driving circuit 10, and the second terminal of the driving circuit 10, respectively, is configured to control to connect the control terminal of the driving circuit 10 and the second terminal of the driving circuit 10 under the control of the third control signal provided by the third control terminal G3;

The first initialization circuit 53 is electrically connected to the first reset control terminal R1, the control terminal of the driving circuit 10, and the third initial voltage terminal I3, respectively, is configured to write the third initial voltage provided by the third initial voltage terminal I3 into the control terminal of the driving circuit 10 under the control of the first reset control signal provided by the first reset control terminal R1, so as to initialize the potential of the control terminal of the driving circuit 10;

The second initialization circuit 54 is electrically connected to the second reset control terminal R2, the anode of the micro light emitting diode M1 and the fourth initial voltage terminal I4 respectively, and is configured to write the fourth initial voltage provided by the fourth initial voltage terminal I4 into the anode of the micro light emitting diode M1 under the control of the second reset control signal provided by the second reset control terminal R2;

A first terminal of the third capacitor C3 is electrically connected to the control terminal of the driving circuit 10, and a second terminal of the third capacitor C3 is electrically connected to the first voltage terminal V1.

In at least one embodiment of the pixel circuit shown in FIG. 29, the first initial voltage terminal, the third initial voltage terminal and the fourth initial voltage terminal may be the same voltage terminal, the first voltage terminal may be a high voltage terminal, and the first control terminal and the third control terminal may be the same control terminal, but not limited thereto.

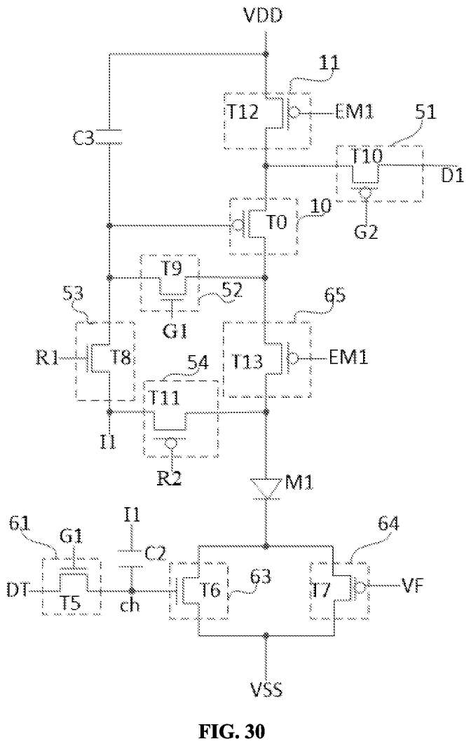

As shown in FIG. 30, on the basis of at least one embodiment of the pixel circuit shown in FIG. 29, the second gating control circuit includes a fifth transistor T5, the third light emitting control circuit includes a sixth transistor T6, the fourth light emitting control circuit includes a seventh transistor T7; the light emitting element is a micro light emitting diode M1; the driving circuit 10 includes a driving transistor T0;

The gate electrode of the fifth transistor T5 is electrically connected to the first control terminal G1, the source electrode of the fifth transistor T5 is electrically connected to the light emitting data voltage terminal DT, and the drain electrode of the fifth transistor T5 is electrically connected to the gating control terminal ch;

The gate electrode of the sixth transistor T6 is electrically connected to the gating control terminal ch, the source electrode of the sixth transistor T6 is electrically connected to the cathode of the micro light emitting diode M1, and the drain electrode of the sixth transistor T6 electrically connected to the low voltage terminal VSS;

The gate electrode of the seventh transistor T7 is electrically connected to the light emitting control voltage terminal VF, the source electrode of the seventh transistor T7 is electrically connected to the cathode of the micro light emitting diode M1, and the drain electrode of the seventh transistor T7 is electrically connected to the low voltage terminal VSS; the light emitting control voltage terminal VF is configured to provide a light emitting control voltage HF;

The light emitting gating circuit also includes a second capacitor C2;

The first terminal of the second capacitor C2 is electrically connected to the gating control terminal ch, and the second terminal of the second capacitor C2 is electrically connected to the first initial voltage terminal I1;

The first initialization circuit 53 includes an eighth transistor T8, the compensation control circuit 52 includes a ninth transistor T9, the data writing-in circuit 51 includes a tenth transistor T10, and the second initialization circuit 54 includes an eleventh transistor T11;

The gate electrode of the eighth transistor T8 is electrically connected to the first reset control terminal R1, the source electrode of the eighth transistor T8 is electrically connected to the first initial voltage terminal I1, and the drain electrode of the eighth transistor T8 is electrically connected to the gate electrode of the driving transistor T0;

The gate electrode of the ninth transistor T9 is electrically connected to the first control terminal G1, the source electrode of the ninth transistor T9 is electrically connected to the gate electrode of the driving transistor T0, and the drain electrode of the ninth transistor T9 electrically connected to the drain electrode of the driving transistor T0;

The gate electrode of the tenth transistor T10 is electrically connected to the second control terminal G2, the source electrode of the tenth transistor T10 is electrically connected to the data line D1, and the drain electrode of the tenth transistor T10 is electrically connected to the source electrode of the driving transistor T0;

The gate electrode of the eleventh transistor T11 is electrically connected to the second reset control terminal R2, the source electrode of the eleventh transistor T11 is electrically connected to the first initial voltage terminal I1, and the drain electrode of the eleventh transistor T11 is electrically connected to the anode of the miniature light emitting diode M1;

The first light emitting control circuit 11 includes a twelfth transistor T12;

The gate electrode of the twelfth transistor T12 is electrically connected to the first light emitting control terminal EM1, the source electrode of the twelfth transistor T12 is electrically connected to the high voltage terminal VDD, and the drain electrode of the twelfth transistor T12 electrically connected to the source electrode of the driving transistor T0;

The fifth light emitting control circuit 65 may include a thirteenth transistor T13;

The gate electrode of the thirteenth transistor M13 is electrically connected to the first light emitting control terminal EM1, the source electrode of the thirteenth transistor M13 is electrically connected to the drain electrode of the driving transistor T0, and the drain electrode of the thirteenth transistor M13 is electrically connected to the anode of the micro LED M1.

In at least one embodiment of the pixel circuit shown in FIG. 30, T5 is an n-type transistor, T6 is an n-type transistor, and T7 is a p-type transistor, but not limited thereto.

In at least one embodiment of the pixel circuit shown in FIG. 30, T8 and T9 are oxide thin film transistors, T0, T10, T11, T12 and T13 may be low temperature polysilicon thin film transistors, but not limited thereto.

In at least one embodiment of the pixel circuit shown in FIG. 30, T6 and T7 form a transmission gate-like structure, and the light emitting data voltage provided by DT and light emitting control voltage HF are respectively connected to both sides of the transmission gate-like structure, and HF is a high frequency PWM signal; when T6 is turned off, the light emitting current path between VDD and VSS is controlled by HF, and high-frequency short-time conduction is performed to realize high-frequency short-time light emitting; when T6 is turned on, the light emitting current path between VDD and VSS is not controlled by HF, the cathode of M1 is turned on to VSS for a long time to realize long-time light emitting.

In at least one embodiment of the pixel circuit shown in FIG. 30, T6 is an n-type transistor, T7 is a p-type transistor, and the transmission gate-like is a CMOS structure or an LTPO structure.

The pixel circuit described in at least one embodiment of the present disclosure can perform PWM dimming to improve the low-gray-scale brightness control capability for the problem of poor brightness uniformity and insufficient low-gray-scale control ability of the light emitting element at low current density.

At least one embodiment of the present disclosure is an LTPO pixel circuit with a PWM dimming function, which solves the problem of poor brightness uniformity at low current density, adopts PAM mode for long-term light emitting at high gray scales, and adopts PWM mode for short-term light emitting at high frequency and low gray scale.

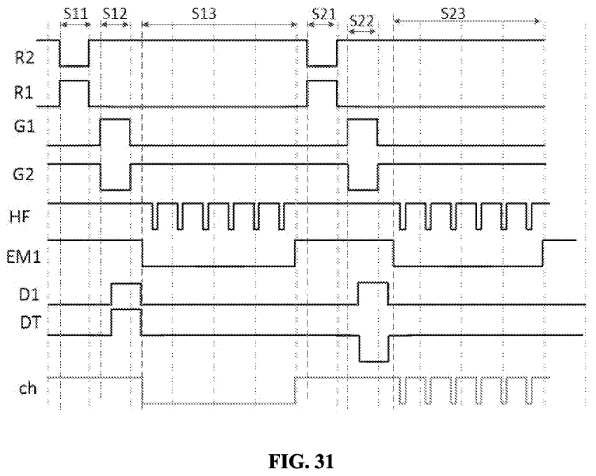

As shown in FIG. 31, when at least one embodiment of the pixel circuit shown in FIG. 30 is working, the first display period includes a first initialization phase S11, a first data writing-in phase S12 and a first light emitting phase S13 that are set successively;

In the first initialization phase S11, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first An initial voltage Vini1 to the gate electrode of T0 and the anode of M1, so that at the beginning of the first data writing-in phase S12, T0 can be turned on, and the residual charge of the anode of M1 can be removed;

In the first initialization phase S11, T9 is turned off, T10 is turned off, T12 is turned off, and T13 is turned off;

In the first data writing-in phase S12, R1 provides a low voltage signal, R2 provides a high voltage signal, G1 provides a high voltage signal, G2 provides a low voltage signal, EM1 provides a high voltage signal, D1 provides a data voltage Vdata, and DT provides a high voltage signal, T10 is turned on to write Vdata into the source electrode of T0;

At the beginning of the first data writing-in phase S12, T0 is turned on, T9 is turned on, and C3 is charged by Vdata to change the potential of the gate electrode of T0 until T0 is turned off, and the potential of the gate electrode of T0 is related to the threshold voltage of T0;

In the first data writing-in phase S12, T8 and T11 are turned off, T12 is turned off, T13 is turned off, and T5 is turned on, so as to control to connect DT to ch, the potential of ch is a high voltage, and T6 is turned on;

In the first light emitting phase S13, R1 provides a low-voltage signal, R2 provides a high-voltage signal, G1 provides a low-voltage signal, G2 provides a high-voltage signal, EM1 provides a low-voltage signal, T12 is turned on, T13 is turned on, and C2 maintains the potential of ch as the high voltage, T6 is turned on, T4 is turned on, and T0 drives M1 to emit light for PAM long-term light emitting;

The second display period includes a second initialization phase S21, a second data writing-in phase S22, and a second light emitting phase S23, which are set successively;

In the second initialization phase S21, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first initial voltage Vini1 to the gate electrode of T0 and the anode of M1, so that at the beginning of the first data writing-in phase S12, T0 can be turned on, and the residual charge of the anode of M1 can be removed;

In the second initialization phase S21, T9 is turned off, T10 is turned off, T12 is turned off, and T13 is turned off;

In the second data writing-in phase S22, R1 provides a low voltage signal, R2 provides a high voltage signal, G1 provides a high voltage signal, G2 provides a low voltage signal, EM1 provides a high voltage signal, D1 provides a data voltage Vdata, and DT provides a low voltage signal, T10 is turned on to write Vdata into the source electrode of T0;

At the beginning of the second data writing-in phase S22, T0 is turned on, T9 is turned on, and C3 is charged by Vdata to change the potential of the gate electrode of T0 until T0 is turned off, and the potential of the gate electrode of T0 is related to the threshold voltage of T0;

In the second data writing-in phase S22, T8 and T11 are turned off, T12 is turned off, T13 is turned off, and T5 is turned on, so as to control to connect DT to ch, the potential of ch is low voltage, and T6 is turned off;

In the second light emitting phase S23, R1 provides a low-voltage signal, R2 provides a high-voltage signal, G1 provides a low-voltage signal, G2 provides a high-voltage signal, EM1 provides a low-voltage signal, T12 is turned on, T13 is turned on, and C1 maintains the potential of ch as the low voltage, T6 is turned off, when the voltage value of HF is the low voltage, T7 is turned on, when T7 is turned on, T0 drives M1 to emit light to perform PWM high-frequency short-term light emitting, and perform low gray scale display.

When at least one embodiment of the pixel circuit shown in FIG. 30 of the present disclosure is in operation, the voltage value of the first initial voltage Vini1 and the voltage value of the low voltage signal provided by VSS can be −2V, and the voltage value of the high voltage signal provided by VDD can be 8V, the high voltage value of the first control signal provided by G1 can be 7V, the low voltage value of the first control signal provided by G1 can be −8V, and the high voltage value of the first light control signal provided by EM1 can be 7V, the low voltage value of the first light emitting control signal provided by EM1 may be −7V, the high voltage value of the light emitting control voltage HF may be 7V, the low voltage value of the light emitting control voltage HF may be −7V, and the voltage value of the data voltage Vdata may be greater than or equal to 4V and less than or equal to 6V, the high voltage value of the light emitting data voltage provided by DT can be 7V, the low voltage value of the light emitting data voltage provided by DT can be −7V, and in the light emitting phase, DT can provide a 0V voltage signal, but not limited thereto.

When at least one embodiment of the pixel circuit shown in FIG. 30 of the present disclosure is working,

In the PWM dimming mode, the potential of ch is kept at a low voltage, and T5 needs a lower turn-off voltage. At this time, the low voltage value of the first control signal provided by G1 can be less than or equal to −8V;

If T7 has a tail lift, HF needs to select an appropriate voltage to prevent that in PWM dimming mode, during the period when EM1 provides a low voltage signal and the voltage value of HF is the high voltage, the current leakage of T7 causes poor turning-off of T7 and nanoampere (nA) level current noise.

In at least one embodiment of the pixel circuit shown in FIG. 30 of the present disclosure, in the PWM dimming mode, when the potential of ch is maintained at a low voltage, T5 is poorly turned off, which easily leads to reverse leakage, so that the potential of ch decreases. As a result, the ability to turn off T6 is reduced, so T5 can use a low-leakage oxide thin film transistor, which is more conducive to maintaining the low potential of ch.

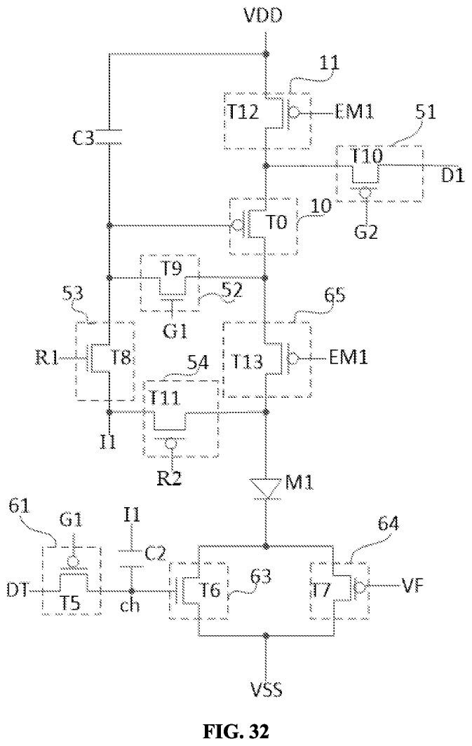

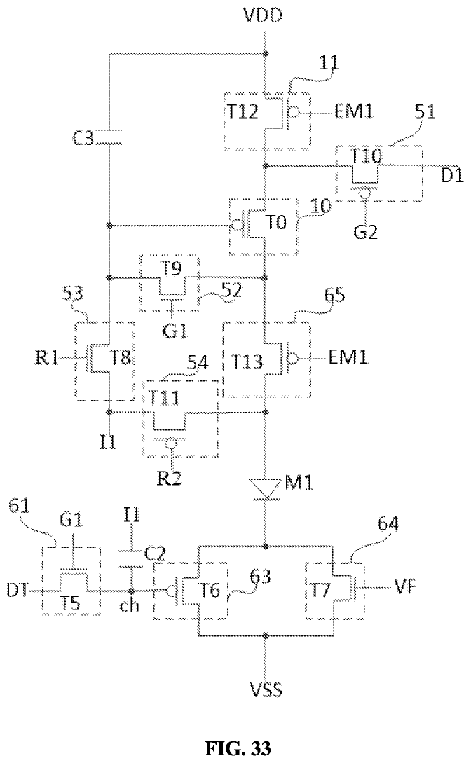

The difference between at least one embodiment of the pixel circuit shown in FIG. 32 of the present disclosure and at least one embodiment of the pixel circuit shown in FIG. 30 of the present disclosure is that: T5 is a p-type transistor, and T5 is a low temperature polysilicon thin film transistor.

The difference between at least one embodiment of the pixel circuit shown in FIG. 33 of the present disclosure and at least one embodiment of the pixel circuit shown in FIG. 30 of the present disclosure is that: T6 is a p-type transistor, and T7 is an n-type transistor.

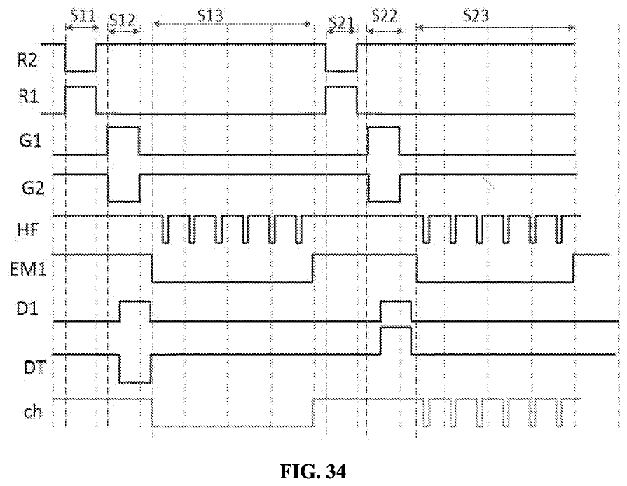

As shown in FIG. 34, when at least one embodiment of the pixel circuit shown in FIG. 33 of the present disclosure is working,

The first display period includes a first initialization phase S11, a first data writing-in phase S12 and a first light emitting phase S13 which are set successively;

In the first initialization phase S11, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first initial voltage Vini1 to the gate electrode of T0 and the anode of M1, so that at the beginning of the first data writing-in phase S12, T0 can be turned on, and the residual charge of the anode of M1 can be removed;

In the first initialization phase S11, T9 is turned off, T10 is turned off, T12 is turned off, and T13 is turned off;

In the first data writing-in phase S12, R1 provides a low voltage signal, R2 provides a high voltage signal, G1 provides a high voltage signal, G2 provides a low voltage signal, EM1 provides a high voltage signal, D1 provides a data voltage Vdata, and DT provides a low voltage signal, T10 is turned on to write Vdata into the source electrode of T0;

At the beginning of the first data writing-in phase S12, T0 is turned on, T9 is turned on, and C3 is charged by Vdata to change the potential of the gate electrode of T0 until T0 is turned off, and the potential of the gate electrode of T0 is related to the threshold voltage of T0;

In the first data writing-in phase S12, T8 and T11 are turned off, T12 is turned off, T13 is turned off, and T5 is turned on, so as to control to connect DT to ch, the potential of ch is a low voltage, and T6 is turned on;

In the first light emitting phase S13, R1 provides a low-voltage signal, R2 provides a high-voltage signal, G1 provides a low-voltage signal, G2 provides a high-voltage signal, EM1 provides a low-voltage signal, T12 is turned on, T13 is turned on, and C2 maintains the potential of ch as the low voltage, T6 is turned on, T4 is turned on, and T0 drives M1 to emit light for PAM long-term light emitting;

The second display period includes a second initialization phase S21, a second data writing-in phase S22, and a second light emitting phase S23, which are set successively;

In the second initialization phase S21, R1 provides a high-voltage signal, R2 provides a low-voltage signal, G1 provides a low-voltage signal, G2 provides a high-voltage signal, EM1 provides a high-voltage signal, T8 and T11 are turned on, and the first initial voltage terminal I1 provides the first initial voltage Vini1 to the gate electrode of T0 and the anode of M1, so that at the beginning of the first data writing-in phase S12, T0 can be turned on, and the residual charge of the anode of M1 can be removed;

In the second initialization phase S21, T9 is turned off, T10 is turned off, T12 is turned off, and T13 is turned off;

In the second data writing-in phase S22, R1 provides a low voltage signal, R2 provides a high voltage signal, G1 provides a high voltage signal, G2 provides a low voltage signal, EM1 provides a high voltage signal, D1 provides a data voltage Vdata, and DT provides a high voltage signal, T10 is turned on to write Vdata into the source electrode of T0;

At the beginning of the second data writing-in phase S22, T0 is turned on, T9 is turned on, and C3 is charged by Vdata to change the potential of the gate electrode of T0 until T0 is turned off, and the potential of the gate electrode of T0 is related to the voltage threshold of T0;

In the second data writing-in phase S22, T8 and T11 are turned off, T12 is turned off, T13 is turned off, and T5 is turned on, so as to control to connect the DT to ch, the potential of ch is a high voltage, and T6 is turned off;

In the second light emitting phase S23, R1 provides a low-voltage signal, R2 provides a high-voltage signal, G1 provides a low-voltage signal, G2 provides a high-voltage signal, EM1 provides a low-voltage signal, T12 is turned on, T13 is turned on, and C1 maintains the potential of ch as the high voltage, T6 is turned off, when the voltage value of HF is the low voltage, T7 is turned on, when T7 is turned on, T0 drives M1 to emit light to perform PWM high-frequency short-term light emitting, and perform low gray scale display.

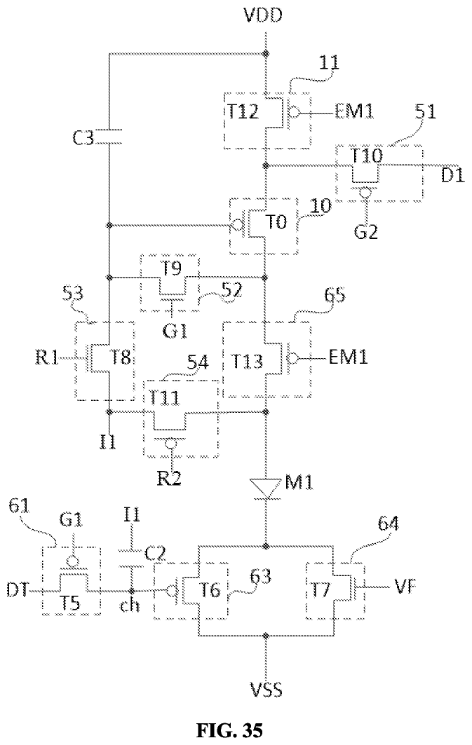

The difference between at least one embodiment of the pixel circuit shown in FIG. 35 of the present disclosure and at least one embodiment of the pixel circuit shown in FIG. 33 of the present disclosure is that T5 is a p-type transistor.

In at least one embodiment of the pixel circuit shown in FIG. 30, FIG. 32, FIG. 33, and FIG. 35 of the present disclosure, D1 and DT can be shared, and the second control signal and the first control signal that are turned on successively are used to charge the gate electrode of T0 and the gating control terminal ch.

In at least one embodiment of the pixel circuits shown in FIG. 30, FIG. 32, FIG. 33, and FIG. 35 of the present disclosure, when the type of T5 is the same as that of T10, that is, T5 and T10 are both p-type transistors or n-type transistors, the control signal connected to the gate electrode of T5 and the control signal connected to the gate electrode of T10 can be shared, and the gate electrode of T0 and the gating control terminal ch are charged simultaneously by different data voltages and light emitting data voltages.

In at least one embodiment of the present disclosure, C2 may not be provided. If the current leakage of T5 is small and the voltage stability of the gating control terminal ch can satisfy the gate on-off state of T6, then C2 may be removed.

In at least one embodiment of the pixel circuit shown in FIG. 30, FIG. 32, FIG. 33, and FIG. 35 of the present disclosure, T8 can be replaced by a p-type transistor, T9 can be replaced by a p-type transistor, and T10 can be replaced by an n-type transistor., but not limited to this.

In at least one embodiment of the pixel circuits shown in FIG. 30, FIG. 32, FIG. 33, and FIG. 35 of the present disclosure, T8 and T9 may be double-gate transistors, and at this time, T8 and T9 may be oxide thin film transistors, or, T8 and T9 may be low temperature polysilicon thin film transistors.

In at least one embodiment of the pixel circuit shown in FIG. 30, FIG. 32, FIG. 33, and FIG. 35 of the present disclosure, since T6 and T7 are on the light emitting current path, the channel width of T6 and the channel width of T7 can be appropriately increased. For example, the channel width of T6 and the channel width of T7 may be greater than or equal to 5 μm and less than or equal to 10 μm, but not limited thereto.

In at least one embodiment of the present disclosure, when T7 is a p-type transistor, T6 is an n-type transistor, and T5 is an n-type transistor, the voltage value of the low voltage signal provided by the first initial voltage Vini1 and VSS may be −2V, the voltage value of the high voltage signal provided by VDD can be 8V, the high voltage value of the first control signal provided by G1 can be 7V, the low voltage value of the first control signal provided by G1 can be −8V; the high voltage value of the first light emitting control signal provided by EM1 can be 7V, the low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 7V, the low voltage value of the light emitting data voltage provided by DT can be −7V, and in the light emitting phase, DT can provide 0V voltage signal, but not limited to.

In at least one embodiment of the present disclosure, when T7 is an n-type transistor, T6 is a p-type transistor, and T5 is an n-type transistor, the voltage value of the low voltage signal provided by the first initial voltage Vini1 and VSS may be −2V, the voltage value of the high voltage signal provided by VDD can be 8V, the high voltage value of the first control signal provided by G1 can be 7V, the low voltage value of the first control signal provided by G1 can be −8V; the high voltage value of the first light emitting control provided by EM1 can be 7V, the low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 7V, the low voltage value of the light emitting data voltage provided by DT can be −7V, and in the light emitting phase, DT can provide 0V voltage signal, but not limited to.

In at least one embodiment of the present disclosure, when T7 is a p-type transistor, T6 is an n-type transistor, and T5 is a p-type transistor, the voltage value of the low voltage signal provided by the first initial voltage Vini1 and VSS may be −2V, the voltage value of the high voltage signal provided by VDD can be 8V, the high voltage value of the first control signal provided by G1 can be 8V, the low voltage value of the first control signal provided by G1 can be −8V; the high voltage value of the first light emitting control signal provided by EM1 can be 7V, the low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 7V, the low voltage value of the light emitting data voltage provided by DT can be −7V, and in the light emitting phase, DT can provide 0V voltage signal, but not limited to.

In at least one embodiment of the present disclosure, when T7 is an n-type transistor, T6 is a p-type transistor, and T5 is a p-type transistor, the voltage value of the low voltage signal provided by the first initial voltage Vini1 and VSS may be −2V, the voltage value of the high voltage signal provided by VDD can be 8V, the high voltage value of the first control signal provided by G1 can be 8V, the low voltage value of the first control signal provided by G1 can be −8V; the high voltage value of the first light emitting control signal provided by EM1 can be 7V, the low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 7V, the low voltage value of the light emitting data voltage provided by DT can be −7V, and in the light emitting phase, DT can provide 0V voltage signal, but not limited to.

In specific implementation, when the light emitting data voltage provided by DT needs to be a positive value,

When T7 is a p-type transistor, T6 is an n-type transistor, and T5 is an n-type transistor, the voltage value of the low-voltage signal provided by the first initial voltage Vini1 and VSS can be −2V, and the voltage value of the high-voltage signal provided by VDD can be 8V, the high voltage value of the first control signal provided by G1 can be 14V, the low voltage value of the first control signal provided by G1 can be −1V; the high voltage value of the first light control signal provided by EM1 can be 7V, the low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 14V, and the low voltage value of the light emitting data voltage provided by DT can be 0V, but not limited thereto.

In specific implementation, when the light emitting data voltage provided by DT needs to be a positive value,

When T7 is an n-type transistor, T6 is a p-type transistor, and T5 is an n-type transistor, the voltage value of the low-voltage signal provided by the first initial voltage Vini1 and VSS can be −2V, and the voltage value of the high-voltage signal provided by VDD can be 8V, the high voltage value of the first control signal provided by G1 can be 14V, the low voltage value of the first control signal provided by G1 can be −1V; the high voltage value of the first light control signal provided by EM1 can be 7V, the low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 14V, and the low voltage value of the light emitting data voltage provided by DT can be 0V, but not limited thereto.

In specific implementation, when the light emitting data voltage provided by DT needs to be a positive value,

When T7 is a p-type transistor, T6 is an n-type transistor, and T5 is a p-type transistor, the voltage value of the low-voltage signal provided by the first initial voltage Vini1 and VSS can be −2V, and the voltage value of the high-voltage signal provided by VDD can be 8V, the high voltage value of the first control signal provided by G1 can be 15V, the low voltage value of the first control signal provided by G1 can be −1V; the high voltage value of the first light control signal provided by EM1 can be 7V, The low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 14V, and the low voltage value of the light emitting data voltage provided by DT can be 0V, but not limited thereto.

In specific implementation, when the light emitting data voltage provided by DT needs to be a positive value,

When T7 is an n-type transistor, T6 is a p-type transistor, and T5 is a p-type transistor, the voltage value of the low-voltage signal provided by the first initial voltage Vini1 and VSS can be −2V, and the voltage value of the high-voltage signal provided by VDD can be 8V, the high voltage value of the first control signal provided by G1 can be 15V, the low voltage value of the first control signal provided by G1 can be −1V; the high voltage value of the first light control signal provided by EM1 can be 7V, The low voltage value of the first light emitting control signal provided by EM1 can be −7V, the high voltage value of HF can be 7V, the low voltage value of HF can be −7V, and the voltage value of the data voltage provided by D1 can be greater than or equal to 4V and less than or equal to 6V, the high voltage value of the light emitting data voltage provided by DT can be 14V, and the low voltage value of the light emitting data voltage provided by DT can be 0V, but not limited thereto.

In at least one embodiment of the present disclosure, when T7 is a p-type transistor, T6 is an n-type transistor, and T5 is an n-type transistor,

In the PWM dimming mode, in the low-voltage maintenance phase of ch, T5 needs a lower turn-off voltage, so the low voltage value of the first control signal provided by G1 needs to be lowered.

In at least one embodiment of the present disclosure, when T7 is an n-type transistor, T6 is a p-type transistor, and T5 is an n-type transistor,

In the PAM dimming mode, when the potential of ch is kept at a high voltage, the high voltage value of the first control signal provided by G1 is required to be greater than or equal to 8V;

In the PWM dimming mode, when the potential of the first control signal provided by G1 is the low voltage, T5 is turned on, and the light emitting data voltage provided by DT is used for low-voltage charging of ch, and the low voltage value of the first control signal provided by G1 is required to be less than or equal to −8V.

In at least one embodiment of the present disclosure, when T7 is a p-type transistor, T6 is an n-type transistor, and T5 is a p-type transistor,

In the PAM dimming mode, in the low-voltage maintenance phase of ch, the potential of the first control signal provided by G1 needs to be low to ensure the turning-off ability of T5.

In at least one embodiment of the present disclosure, when T7 is an n-type transistor, T6 is a p-type transistor, and T5 is a p-type transistor,

In the PAM dimming mode, in the low-voltage maintenance phase of ch, the potential of the first control signal provided by G1 needs to be low to ensure the turning-off ability of T5.

The pixel driving method described in at least one embodiment of the present disclosure is applied to the above-mentioned pixel circuit, and the pixel driving method includes:

Controlling, by the first light emitting control circuit, to connect the first voltage terminal and the first terminal of the driving circuit under the control of the first light emitting control signal during the light emitting phase;

Controlling, by the light emitting gating circuit, under the control of the first control signal, according to the light emitting data voltage, in the light emitting phase, to generate a current path between the second terminal of the driving circuit and the light emitting element under the control of the light emitting control voltage provided by the light emitting control voltage terminal, to control the driving circuit to control the light emitting element to emit light, or to control to generate the current path between the second terminal of the driving circuit and the light emitting element during the light emitting phase, to control the driving circuit to control the light emitting element to emit light.

In at least one embodiment of the present disclosure, the light emitting gating circuit includes a second light emitting control circuit and a first gating control circuit; the pixel driving method includes:

Writing, by the first gating control circuit, the light emitting data voltage into the gating control terminal under the control of the first control signal, and controlling to connect the second light emitting control terminal and the light emitting control voltage terminal or connect the second light emitting control terminal and the first light emitting control terminal under the control of a potential of the gating control terminal;

Controlling, by the second light emitting control circuit, to connect the second terminal of the driving circuit and the first electrode of the light emitting element under the control of the potential of the second light emitting control terminal.

In at least one embodiment of the present disclosure, the light emitting gating circuit includes a second gating control circuit, a third light emitting control circuit, and a fourth light emitting control circuit; the pixel driving method includes:

Writing, by the second gating control circuit, the light emitting control voltage into the gating control terminal under the control of the first control signal;

Controlling, by the third light emitting control circuit, to connect the second electrode of the light emitting element and the second voltage terminal under the control of a potential of the gating control terminal;

Controlling, by the fourth light emitting control circuit, to connect the second electrode of the light emitting element and the second voltage terminal under the control of the light emitting control voltage.

The display device described in the embodiment of the present disclosure includes the above-mentioned pixel circuit.

The display device provided by the embodiments of the present disclosure may be any product or component with a display function, such as a wearable device, a mobile phone, a tablet computer, a television, a monitor, a notebook computer, a digital photo frame, a navigator, and the like.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A pixel circuit, comprising a first light emitting control circuit, a light emitting element, a driving circuit and a light emitting gating circuit;
the first light emitting control circuit is electrically connected to a first light emitting control terminal, a first voltage terminal and a first terminal of the driving circuit respectively, and is configured to control to connect the first voltage terminal and the first terminal of the driving circuit under the control of a first light emitting control signal provided by the first light emitting control terminal during a light emitting phase;
a second terminal of the driving circuit is electrically connected to a first electrode of the light emitting element, and the driving circuit is configured to drive the light emitting element;
the light emitting gating circuit is configured to, under the control of a first control signal provided by a first control terminal, according to a light emitting data voltage provided by a light emitting data voltage terminal, in the light emitting phase, generate a current path between the second terminal of the driving circuit and the light emitting element under the control of a light emitting control voltage provided by a light emitting control voltage terminal, to control the driving circuit to control the light emitting element to emit light, or, to generate the current path between the second terminal of the driving circuit and the light emitting element in the light emitting phase, to control the driving circuit to control the light emitting element to emit light.

2. The pixel circuit according to claim 1, wherein the light emitting gating circuit comprises a second light emitting control circuit and a first gating control circuit;
the first gating control circuit is electrically connected to the first control terminal, the light emitting data voltage terminal, a gating control terminal, a second light emitting control terminal, the light emitting control voltage terminal and a first light emitting control terminal, is configured to write the light emitting data voltage provided by the light emitting data voltage terminal into the gating control terminal under the control of the first control signal, and under the control of a potential of the gating control terminal, control to connect the second light emitting control terminal and the light emitting control voltage terminal, or control to connect the second light emitting control terminal and the first light emitting control terminal;
the second light emitting control circuit is electrically connected to the second light emitting control terminal, the second terminal of the driving circuit and the first electrode of the light emitting element respectively, and is configured to control to connect the second terminal of the driving circuit and the first electrode of the light emitting element under the control of a potential of the second light emitting control terminal;
the second electrode of the light emitting element is electrically connected to a second voltage terminal.

3. The pixel circuit according to claim 2, wherein the light emitting gating circuit further comprises a first capacitor;
a first terminal of the first capacitor is electrically connected to the gating control terminal, and a second terminal of the first capacitor is electrically connected to the first initial voltage terminal.

4. The pixel circuit according to claim 2, wherein the first gating control circuit comprises a first transistor, a second transistor and a third transistor;
a control electrode of the first transistor is electrically connected to the first control terminal, a first electrode of the first transistor is electrically connected to the light emitting data voltage terminal, and a second electrode of the first transistor is electrically connected to the gating control terminal;
a control electrode of the second transistor is electrically connected to the gating control terminal, a first electrode of the second transistor is electrically connected to the light emitting control voltage terminal, and a second electrode of the second transistor is electrically connected to the second light emitting control terminal;
a control electrode of the third transistor is electrically connected to the gating control terminal, a first electrode of the third transistor is electrically connected to the first light emitting control terminal, and a second electrode of the third transistor is electrically connected to the second light emitting control terminal.

5. The pixel circuit according to claim 2, wherein the second light emitting control circuit comprises a fourth transistor;
a control electrode of the fourth transistor is electrically connected to the second light emitting control terminal, a first electrode of the fourth transistor is electrically connected to the second terminal of the driving circuit, and a second electrode of the fourth transistor is electrically connected to the first electrode of the light emitting element.

6. The pixel circuit according to claim 4, wherein the first transistor is an n-type transistor, the second transistor is a p-type transistor, and the third transistor is an n-type transistor; or,
the first transistor is an n-type transistor, the second transistor is an n-type transistor, and the third transistor is a p-type transistor; or,
the first transistor is a p-type transistor, the second transistor is an n-type transistor, and the third transistor is a p-type transistor.

7. The pixel circuit according to claim 6, wherein when the second transistor is a p-type transistor and the third transistor is an n-type transistor, a width-to-length ratio of a channel of the third transistor is greater than a width-to-length ratio of a channel of the second transistor.

8. The pixel circuit according to claim 2, wherein the light emitting gating circuit includes a second gating control circuit, a third light emitting control circuit, and a fourth light emitting control circuit;
the second gating control circuit is electrically connected to the first control terminal, the light emitting data voltage terminal, and the gating control terminal, and is configured to control to write the light emitting data voltage into the gating control terminal under the control of the first control signal;
the third light emitting control circuit is electrically connected to the gating control terminal, the second electrode of the light emitting element and the second voltage terminal, and is configured to control to connect the second electrode of the light emitting element and the second voltage terminal under the control of the potential of the gating control terminal;
the fourth light emitting control circuit is electrically connected to the light emitting control voltage terminal, the second electrode of the light emitting element and the second voltage terminal respectively, and is configured to control to connect the second electrode of the light emitting element and the second voltage terminal under the control of the light emitting control voltage provided by the light emitting control voltage terminal.

9. The pixel circuit according to claim 8, further comprising a fifth light emitting control circuit; wherein
the fifth light emitting control circuit is electrically connected to the first light emitting control terminal, the second terminal of the driving circuit and the first electrode of the light emitting element respectively, and is configured to control to connect the second terminal of the driving circuit and the first electrode of the light emitting element under the control of the first light emitting control signal.

10. The pixel circuit according to claim 8, wherein the light emitting gating circuit further comprises a second capacitor;
a first terminal of the second capacitor is electrically connected to the gating control terminal, a second terminal of the second capacitor is electrically connected to the first initial voltage terminal.

11. The pixel circuit according to claim 8, wherein the second gating control circuit includes a fifth transistor, the third light emitting control circuit includes a sixth transistor, and the fourth light emitting control circuit includes a seventh transistor;
a control electrode of the fifth transistor is electrically connected to the first control terminal, a first electrode of the fifth transistor is electrically connected to the light emitting data voltage terminal, and a second electrode of the fifth transistor is electrically connected to the gating control terminal;
a control electrode of the sixth transistor is electrically connected to the gating control terminal, a first electrode of the sixth transistor is electrically connected to the second electrode of the light emitting element, a second electrode of the sixth transistor is electrically connected to the second voltage terminal;
a control electrode of the seventh transistor is electrically connected to the light emitting control voltage terminal, a first electrode of the seventh transistor is electrically connected to the second electrode of the light emitting element, and a second electrode of the seventh transistor is electrically connected to the second voltage terminal.

12. The pixel circuit according to claim 11, wherein the seventh transistor is a p-type transistor, the sixth transistor is an n-type transistor, and the fifth transistor is an n-type transistor; or,
the seventh transistor is a p-type transistor, the sixth transistor is an n-type transistor, and the fifth transistor is a p-type transistor; or,
the seventh transistor is an n-type transistor, the sixth transistor is a p-type transistor, and the fifth transistor is an n-type transistor; or,
the seventh transistor is an n-type transistor, the sixth transistor is a p-type transistor, and the fifth transistor is a p-type transistor.

13. The pixel circuit according to claim 1, further comprising a data writing-in circuit, a compensation control circuit, a first initialization circuit, a second initialization circuit and a third capacitor;
the data writing-in circuit is electrically connected to a second control terminal, a data line and the first terminal of the driving circuit, and is configured to write the data voltage provided by the data line into the first terminal of the driving circuit under the control of a second control signal provided by the second control terminal;
the compensation control circuit is electrically connected to a third control terminal, the control terminal of the driving circuit and the second terminal of the driving circuit respectively, and is configured to control to connect the control terminal of the driving circuit and the second terminal of the driving circuit under the control of a third control signal provided by the third control terminal;
the first initialization circuit is electrically connected to a first reset control terminal, the control terminal of the driving circuit and a third initial voltage terminal respectively, and is configured to write a third initial voltage provided by the third initial voltage terminal into the control terminal of the driving circuit under the control of a first reset control signal provided by the first reset control terminal;
the second initialization circuit is electrically connected to a second reset control terminal, the first electrode of the light emitting element and a fourth initial voltage terminal respectively, and is configured to write a fourth initial voltage provided by the fourth initial voltage terminal into the first electrode of the light emitting element under the control of a second reset control signal provided by the second reset control terminal;
a first terminal of the third capacitor is electrically connected to the control terminal of the driving circuit, and a second terminal of the third capacitor is electrically connected to the first voltage terminal.

14. The pixel circuit according to claim 13, wherein the first initialization circuit includes an eighth transistor, the compensation control circuit includes a ninth transistor, the data writing-in circuit includes a tenth transistor, and the second initialization circuit includes an eleventh transistor;
a control electrode of the eighth transistor is electrically connected to the first reset control terminal, a first electrode of the eighth transistor is electrically connected to the third initial voltage terminal, and the a electrode of the eighth transistor is electrically connected to the control terminal of the driving circuit;
a control electrode of the ninth transistor is electrically connected to the third control terminal, a first electrode of the ninth transistor is electrically connected to the control terminal of the driving circuit, and a second electrode of the ninth transistor is electrically connected to the second terminal of the driving circuit;
a control electrode of the tenth transistor is electrically connected to the second control terminal, a first electrode of the tenth transistor is electrically connected to the data line, and a second electrode of the tenth transistor is electrically connected to the first terminal of the driving circuit; or the control electrode of the tenth transistor is electrically connected to the first reset control terminal, the first electrode of the tenth transistor is electrically connected to the light emitting data voltage terminal, and a second electrode of the tenth transistor is electrically connected to the first terminal of the driving circuit;
a control electrode of the eleventh transistor is electrically connected to the second reset control terminal or the first reset control terminal, a first electrode of the eleventh transistor is electrically connected to the fourth initial voltage terminal, and a second electrode of the eleventh transistor is electrically connected to the first electrode of the light emitting element.

15. The pixel circuit according to claim 14, wherein the eighth transistor and the ninth transistor are oxide thin film transistors; or at least one of the eighth transistor and the ninth transistor is a double-gate transistor,
the eleventh transistor is an oxide thin film transistor, and a control electrode of the eleventh transistor is electrically connected to the first reset control terminal.

16.-17. (canceled)

18. The pixel circuit according to claim 1, wherein the light emitting element is a micro light emitting diode or a miniature light emitting diode.

19. A pixel driving method, applied to the pixel circuit according to claim 1, comprising:
controlling, by the first light emitting control circuit, to connect the first voltage terminal and the first terminal of the driving circuit under the control of the first light emitting control signal in the light emitting phase;
controlling, by the light emitting gating circuit, under the control of the first control signal, according to the light emitting data voltage, in the light emitting phase, to generate a current path between the second terminal of the driving circuit and the light emitting element under the control of the light emitting control voltage provided by the light emitting control voltage terminal, to control the driving circuit to control the light emitting element to emit light, or to control to generate the current path between the second terminal of the driving circuit and the light emitting element in the light emitting phase, to control the driving circuit to control the light emitting element to emit light.

20. The pixel driving method according to claim 19, wherein the light emitting gating circuit includes a second light emitting control circuit and a first gating control circuit; the pixel driving method includes:
writing, by the first gating control circuit, the light emitting data voltage into the gating control terminal under the control of the first control signal, and controlling to connect the second light emitting control terminal and the light emitting control voltage terminal or connect the second light emitting control terminal and the first light emitting control terminal under the control of a potential of the gating control terminal;
controlling, by the second light emitting control circuit, to connect the second terminal of the driving circuit and the first electrode of the light emitting element under the control of a potential of the second light emitting control terminal.

21. The pixel driving method according to claim 19, wherein the light emitting gating circuit includes a second gating control circuit, a third light emitting control circuit, and a fourth light emitting control circuit; the pixel driving method includes:
writing, by the second gating control circuit, the light emitting control voltage into the gating control terminal under the control of the first control signal;
controlling, by the third light emitting control circuit, to connect the second electrode of the light emitting element and the second voltage terminal under the control of a potential of the gating control terminal;
controlling, by the fourth light emitting control circuit, to connect the second electrode of the light emitting element and the second voltage terminal under the control of the light emitting control voltage.

22. A display device comprising the pixel circuit according to claim 1.
